(19) United States
(12) Patent Application Publication
(10) Pub. No.: US 2006/0141241 A1
(43) Pub. Date: Jun. 29, 2006

(54) Peelable breakaway multi-layered structures and methods and compositions for making such structures

(76) Inventors: Dennis Lee Carespodi, Winston-Salem, NC (US); Charles Ray Ashcraft, Winston-Salem, NC (US)

Correspondence Address: KILPATRICK STOCKTON LLP, 1001 WEST FOURTH STREET, WINSTON-SALEM, NC, 27101, US

(21) Appl. No.: 11/021,392

(22) Filed: Dec. 23, 2004

(51) Int. Cl. B32B 27/32; B32B 5/16; C08K 3/34

(52) U.S. Cl. 428/327; 428/411.1; 428/523; 524/442; 524/502

(57) ABSTRACT

Disclosed are peelable multi-layered structures and methods and compositions for making such structures. In one example embodiment, the structure may include a structural layer and a peelable breakaway layer that functions by cohesive failure. The composition used for the breakaway layer may be made of a first matrix into which is blended a second composition that is dispersed the matrix. For example, a matrix of a first polymer may be blended with a second polymer that is at least partly incompatible with the first polymer, and at least 10% of an inert filler.

### FIELD OF INVENTION

The present invention relates to peelable breakaway multi-layered structures that may be used as a protective covering for packaging and the like, and methods and compositions for making such structures.

### BACKGROUND

Containers and packages often require some type of peelable closure element, such as a lid, cover, or seal. Sealed containers may be produced in a variety of shapes and sizes. For example, containers may be rigid or semi-rigid molds containing multiple wells or blisters to package individual items, or flexible pouches such as those designed to hold medical devices, or a single package or container that can hold multiple items. Examples of such sealable packaging may include containers used to package food, or packages used for articles that need to remain sterile and/or sanitary, such as medical supplies or equipment, or pharmaceuticals. The packaging used for such items may be made of glass, paper, metal, or plastic, or a combination of such materials. Often, plastic is preferred as a packaging material, as plastic is relatively inexpensive, physically durable, and can be easily molded into various shapes and sizes. Also, metal foils may be used, as foil generally provides good barrier properties to the transfer of gas and moisture, and like plastic, is both moldable and durable. In addition, both foil and plastic may be fashioned in a way that makes the package attractive for the user or consumer.

Peelable laminates are typically multi-layered structures that may be peeled from a substrate to which the laminate has been applied. Generally, the laminate is sealed to the substrate in some manner. Peelable laminates may be used in container and packaging technologies as a means to provide a protective covering that can be removed by peeling.

For example, peelable sealed packages may be made by using a peelable laminate to cover the package opening. The type of material used to form the peelable seal used may depend upon the substrate for which the peelable seal is to be used. Thus, peelable laminates adhered to metal containers may have different requirements than laminates that are adhered to plastic containers. Also, the type of seal may depend on the level of protection that the peelable seal provides. For example, a peelable laminate may be made using either metal material or plastic depending on the type of strength and barrier capabilities that may be required.

Although peelable laminates are widely used, such laminates may be problematic if there is a large variability of peel strength required to open different seals. For example, for some laminates, as the temperature used for sealing is increased, the force required to peel the laminate from the seal point may increase. There is a tendency for manufacturers of some products (e.g., sterile items, or food and other perishable items) to seal the packaging at a high temperature to thereby create a high seal strength. Such packages, although resistant to inadvertent opening of the seal, may be difficult for the endpoint user to open. Thus, rather than peeling apart the sealed opening, the user may have to cut the package open at a different point, thereby compromising the overall packaging. Or, rather than cleanly pealing, the laminate may tear when opened. Also, sealing at high temperatures may cause melting at the interface where the laminate is sealed to the package, resulting in mixing of the sealant material and container material to form a package that is difficult to open.

As additional materials are used to make containers for which a peelable seal or covering is required, there is a need to develop peelable structures that may be reliably sealed to a substrate (such as a container) to protect either the substrate or items contained within, but that can be readily removed from the substrate as required. Also, there is a need to develop peelable structures that have a defined peel strength, regardless of the temperature used for sealing. Such materials may provide for the development of packaging that may be reliably sealed at high temperatures, but that is still openable using a peel force that may be applied by the average user or consumer of the product. Also, such materials may provide for a peelable package that may be easily opened even where there is some intermixing between the container and the material used to seal the container.

### SUMMARY OF THE INVENTION

Embodiments of the present invention comprise peelable multi-layered structures and methods and compositions for making such structures. The present invention may be embodied in a variety of ways.

In one embodiment, the present invention comprises a composition for use as a peelable breakaway layer in a multi-layer structure comprising a matrix into which is blended a second composition that is at least partly incompatible with the matrix, such that the breakaway layer functions by cohesive failure. In one embodiment, the incompatible composition is uniformly dispersed in the matrix.

In another embodiment, the present invention comprises a composition for use as a peelable breakaway layer that functions by cohesive failure in a multi-layer structure comprising a polymer blend comprising an inert filler, wherein the filler is substantially dispersed in the polymer blend, such that the peelable breakaway layer functions by cohesive failure of the layer. In one embodiment, the filler is uniformly dispersed in the blend. The matrix may comprise a first polymer into which a composition that is at least partly incompatible with the first polymer is mixed. In one embodiment, the polymer blend may comprise a first polymer and a second polymer that is at least partly incompatible with the first polymer, such that the second polymer comprises discrete islands in the first polymer. Also, an inert filler may be added to the polymer blend. Thus, the first polymer may comprise the matrix, and the second polymer and the filler may comprise a fraction that is at least partly incompatible with the matrix. Using a second polymer may reduce the amount of filler that may be required. In yet another embodiment, one of the polymers may be a linear polyolefin and the other polymer may be a branched chain polyolefin.

The present invention also comprises a multi-layered structure. In one embodiment, the structure may comprise a structural layer, and a peelable breakaway layer that functions by cohesive failure, where the breakaway layer comprises a first matrix into which is blended a second composition that is at least partly incompatible with the matrix. For example, the structure may comprise: (a) a first structural layer; and (b) a second peelable breakaway layer comprising a polymer blend having an inert filler, wherein the filler is substantially dispersed in the polymer blend. In one embodiment, the filler is uniformly dispersed in the blend. In one embodiment, the polymer blend may comprise a first polymer, and a second polymer that is at least partly incompatible with the first polymer, such that the second polymer comprises discrete islands in the first polymer.

The present invention also comprises articles of manufacture made using the compositions of the present invention. The article of manufacture may comprise a composition that acts as a peelable breakaway layer that functions by cohesive failure, wherein the composition comprises a first matrix into which is blended a second composition that is at least partly incompatible with the matrix. For example, the composition may comprise a polymer blend comprising an inert filler, wherein the filler is substantially dispersed in the blend. In one embodiment, the filler is uniformly dispersed in the blend. In one embodiment, the breakaway layer may comprise a polymer blend having a first polymer, and a second polymer that is at least partly incompatible with the first polymer, such that the second polymer comprises discrete islands in the first polymer.

The articles of manufacture of the present invention may also be embodied as a multi-layered structure. Thus, in one embodiment, the article of manufacture may comprise: (a) a structural layer; and (b) a peelable breakaway layer that functions by cohesive failure, wherein the breakaway layer comprises a first matrix into which is blended a second composition that is at least partly incompatible with the matrix. In one embodiment, the breakaway layer may comprise a polymer blend comprising an inert filler, wherein the filler is substantially dispersed in the blend. In one embodiment, the filler is uniformly dispersed in the blend. For example, the polymer blend may comprise a first polymer, and a second polymer that is at least partly incompatible with the first polymer, such that the second polymer comprises discrete islands in the first polymer.

Embodiments of the present invention also comprise methods for making compositions that may be used to make peelable multi-layered structures. In one embodiment, the present invention comprises a method of making a composition for use as a peelable breakaway layer in a multi-layer structure comprising: (a) blending a first polymer, and a second polymer, such that the second polymer comprises discrete islands in the first polymer; and (b) dispersing an inert filler in the blend, such that the filler is substantially dispersed in the blend.

Various embodiments of the present invention may provide certain advantages. The peelable structures made using the compositions of the present invention may be reliably sealed to a variety of polymer substrates (such as used for packaging containers) to protect either the substrate or items contained within, but can be readily peeled from the substrate as required. Also, the compositions used as peelable breakaway layers of the present invention may provide a relatively uniform peel strength regardless of the temperature used for sealing the breakaway layer to another surface. This can provide for the use of high temperatures for sealing, but still allow the consumer or user to readily peel the laminate.

The present invention may be better understood by reference to the description and figures that follow. It is to be understood that the invention is not limited in its application to the specific details as set forth in the following description and figures. The invention is capable of other embodiments and of being practiced or carried out in various ways.

### BRIEF DESCRIPTION OF THE DRAWINGS

FIG. 1 shows a schematic representation of a cross-sectional view of a peelable laminate sealed to a container-type substrate in accordance with an example embodiment of the present invention.

FIG. 2 shows a schematic representation of a perspective view of a peelable laminate sealed to a planar substrate in accordance with an example embodiment of the present invention.

FIG. 3 shows a schematic representation of a cross-sectional view of a peelable laminate being peeled from a container in accordance with an example embodiment of the present invention.

FIG. 4 shows a schematic representation of a cross-sectional view of a peelable laminate pouch where one side of the pouch opening is being peeled from a second side of the opening in accordance with an example embodiment of the present invention.

FIG. 5 shows a schematic representation of a cross-sectional view of a peelable laminate in accordance with a first example embodiment of the present invention.

FIG. 6 shows a schematic representation of a cross-sectional view of a peelable laminate in accordance with a second example embodiment of the present invention.

FIG. 7 shows a schematic representation of a cross-sectional view of a peelable laminate in accordance with a third example embodiment of the present invention.

FIG. 8 shows a schematic representation of a cross-sectional view of a peelable laminate in accordance with a fourth example embodiment of the present invention.

FIG. 9 shows a schematic representation of a cross-sectional view of a peelable laminate in accordance with a fifth example embodiment of the present invention.

FIG. 10 shows a schematic representation of a cross-sectional view of a peelable laminate in accordance with a sixth example embodiment of the present invention.

FIG. 11 shows a schematic representation of a cross-sectional view of a peelable laminate in accordance with a seventh example embodiment of the present invention.

FIG. 12 shows a schematic representation of a cross-sectional view of a peelable laminate in accordance with an eighth example embodiment of the present invention.

FIG. 13 shows a schematic representation of a cross-sectional view of a peelable laminate in accordance with a ninth example embodiment of the present invention.

FIG. 14 shows results from an experiment in which a peelable composition of the present invention was sealed to various substrates in accordance with an embodiment of the present invention.

### DETAILED DESCRIPTION

Thus, embodiments of the present invention comprise peelable multi-layered structures and compositions and methods for making such structures.

As used herein, a “laminate” refers to a type of multi-layered structure having layers adhered to each other.

Also, as used herein, the term “peelable” refers to the capacity of two materials to separate and release each other. A peelable laminate thus comprises a laminate that may be peeled from a substrate (i.e., a structure that is not part of the laminate) to which the laminate has been applied. Peelable multi-layered structures, such as peelable laminates, may be characterized as providing “cohesive failure” at the point of the seal or “adhesive failure” at the point of seal. By “adhesive failure” it is meant that the layers are peeled from one another cleanly, such that there is no tearing within an individual layer. In contrast, cohesive peeling results in tearing within at least one of the layers during the peel process.

A “breakaway” layer comprises a composition that when applied to a substrate may be removed from the substrate such that there is cohesive failure within the breakaway layer.

As used herein, a “matrix” is a homogeneous material into which a second compound, composition, or material may be dispersed in a uniform manner wherein the particles are substantially dispersed or a non-uniform manner.

Generally, as used herein, “application of” or “applying” a laminate to a substrate involves some type of adhesion or seal between the laminate and the substrate. Sealing may be performed by heat-sealing, or by other sealing techniques as may be known in the art.

Also, as used to refer to the filler that may be used in the breakaway layers of the present invention, the terms “inert” or “incompatible” refer to a substance that is physically and/or chemically distinct from the material to which it is added, so as to remain as a discrete entity from the material to which it is added. For example, an inert particulate filler may comprise a material that when suspended in a polymer blend, remains in the form of discrete particles. An incompatible polymer is a polymer that when mixed with a second polymer, can form discrete islands or pockets in the second polymer. An incompatible polymer may comprise chemical groups that are distinct from the chemical groups present on a second polymer such that the two polymers do not readily mix. Such incompatible or inert materials may be detected by physical measurements made on the compositions to which the inert or incompatible material has been added.

Thus, the present invention provides compositions that may be used to form a peelable multi-layered structure. In one embodiment, the multi-layer structure may be sealed, or otherwise adhered to, a substrate. As used herein, a substrate is a structure that is separate from the peelable laminate and to which the peelable laminate may be applied. The compositions of the present invention rely on the use of an inert or incompatible material that is mixed into a matrix to provide a breakaway material that has a weaker intralayer bonding strength (i.e., bonding to itself) than the seal strength of a layer of the breakaway material to a substrate to which it is applied. When a multi-layer structure comprising the peelable breakaway composition of the present invention is peeled from a substrate, there may be cohesive failure in the breakaway layer of the structure, to allow the multi-layer structure to be peeled from the substrate.

Thus, in one embodiment, the present invention comprises a composition for use as a peelable breakaway layer in a multi-layer structure comprising a first matrix into which is blended a second composition that is at least partly incompatible with the matrix. In this way, the cohesive force within the matrix of the breakaway layer may be formulated to be less than the adhesive force between the breakaway layer and a second substrate material to which the breakaway composition is applied.

The matrix may comprise a first polymer, and the second composition may comprise an inert filler. Also, in one embodiment, the second composition may comprise a polymer. For example, the second polymer may form discrete islands in the matrix. The second composition may be substantially dispersed in the matrix. In one embodiment, the filler is uniformly dispersed. In one embodiment, using a second polymer may reduce the amount of filler required.

Thus, in one embodiment, the present invention comprises a composition for use as a peelable breakaway layer in a multi-layer structure comprising a polymer blend comprising an inert filler, wherein the filler is substantially dispersed in the polymer blend, such that the breakaway layer functions by cohesive failure. In one embodiment, the filler is uniformly dispersed in the blend. The polymer blend may comprise a variety of polymers to form the blend, depending upon the substrate to which the peelable breakaway layer is to be applied. The polymer blend may be formulated to have a distinct macromolecular structure that results in the desired cohesiveness within the blend. In this way, the blend may be formulated such that the cohesive force within the polymer blend is less than the adhesive force between the polymer blend and a second substrate material to which the breakaway composition may be applied.

In one embodiment, the polymer blend may comprise a first polymer, and a second polymer that is at least partly incompatible with the first polymer, such that the second polymer comprises discrete islands in the first polymer. In one embodiment, at least about 40% of the first polymer, and at least about 10% of the second polymer may be used. Or, at least 50% of the first polymer may be used. The islands of the second polymer may be 20 μm or less in diameter. In alternative embodiments, the islands of the second polymer may range from about 1 μm to about 20 μm in diameter, or from about 5 μm to about 10 μm in diameter. In one embodiment, using a second polymer may reduce the amount of filler required.

In one embodiment, the composition may be used to prepare peelable multi-layer structures that may be applied to plastic substrates. For example, the peelable breakaway layer may be positioned to be peeled from a substrate comprising a linear polyolefin, and/or a branched-chain polyolefin. Thus, the first polymer may comprise a linear polyolefin and the second polymer may comprise a branched-chain polyolefin. Or, the first polymer may comprise a branched-chain polyolefin and the second polymer may comprise a linear polyolefin. Or, the first polymer may comprise a linear or branched chain polyolefin and the second polymer may comprise an acid modified polyolefin.

As used herein, linear polymers are polymers that are defined as linear in the art. Linear polymers may be produced by coordination or condensation polymerization and comprise branching of about 0.5 to 3 groups per 500 monomers, as opposed to branched polymers that may be formed by free radical polymerization and that comprise branching on the order of 15 to 30 groups per 500 monomer units (Odian, G., Principals of Polymerization, p. 656, John Wiley & Sons, Inc., 1991). A variety of linear polymers may be used. For example, in one embodiment, the linear polymer may comprise a linear polyolefin. Linear polyolefins that may be used comprise a polyethylene polymer such as high density PE (HDPE), or isotactic polypropylene (PP). A variety of branched-chain polymers may be used. In one embodiment, the branched-chain polymer may comprise a branched-chain polyolefin. For example, the branched-chain polyolefin may comprise atactic or syndiotactic polypropylene homopolymer or copolymer, or a polybutylene homopolymer or copolymer. Also, the branched chain polyolefin may comprise a polyethylene (PE) homopolymer or copolymer, such as low density PE (LDPE), medium density PE (MDPE), linear low density PE (LLDPE), and PE copolymers, such as ethylene vinylacetate (EVA).

For example, in one embodiment, at least one of the polymers may comprise a polyethylene homopolymer or copolymer. Alternatively or additionally, at least one of the polymers may comprise a polypropylene homopolymer or copolymer. Alternatively or additionally, at least one of the polymers may comprise a polybutylene homopolymer or copolymer.

A variety of materials may be used as an inert filler. In one embodiment, the inert filler may comprise a particulate inorganic filler. Such inorganic filler may include talc, calcium carbonate, silica, aluminum trihydrate, feldspar, zeolite, koalinite (aluminum silicate), aluminum oxide, calcined clay, diatomaceous earth, titanium dioxide, barium sulfite, or glass or ceramic microspheres.

Alternatively, the inert filler may comprise an organic polymer that is at least partly incompatible with the polymer or polymers used to make the breakaway layer. Where the polymer blend comprises a linear polyolefin and/or a branched-chain polyolefin, such incompatible polymers may comprise a polyamide homopolymer or copolymer (e.g., nylon), polyethylene terephthalate, ethylene vinyl alcohol (EVOH), polyvinylchloride (PVC), polyvinyl alcohol (PVOH), cellulose acetate, polycarbonate, polyethylene naphthalate (PEN), polyglycolic acid (PGA), polystryene, polytetrafluoroethylene (i.e., TEFLON®), or polyoxyethylene.

The inert filler may be used at an amount that promotes cohesive failure, but that does not interfere with other desired properties (e.g., sealant properties, barrier properties, flexibility) of the composition. For example, the inert filler may be used at an amount that comprises about 5% to about 40% by weight of the composition used for the breakaway layer. Or, in alternate embodiments, the inert filler may be used at an amount that comprises about 5% to about 20% by weight, or about 10% to about 20% by weight, or about 10% to about 15% by weight, of the composition used for the breakaway layer.

The polymer blend may also include additional polymers. For example the composition may comprise an acid-containing or acid-modified polymer to promote adhesion of the peelable composition to a second material. In an embodiment, the polymer to promote adhesion may comprise a maleic acid anhydride (MAA) grafted polyolefin or a MAA copolymer.

Or, an additional polymer may be added to modify the characteristics of the breakaway layer. For example, for substrates such as containers that include cyclic olefin polymers, a cyclic olefin copolymer (COC) may be included in the polymer blend of the present invention.

The present invention also comprises multi-layered structures in which one of the layers comprises a composition to form a breakaway layer that when sealed to a substrate, may be peeled from the substrate. In an embodiment, peeling of the multi-layered structure from a substrate occurs by cohesive failure of at least one breakaway layer of the multi-layered structure.

In one embodiment, the multi-layered structure may comprise a peelable breakaway layer that functions by cohesive failure. The breakaway layer may comprise a first matrix into which is blended a second composition that is at least partly incompatible with the matrix. The matrix may comprise a first polymer, and the second composition may comprise an inert filler. Also, in one embodiment, the second composition may comprise a second polymer that when blended with the first polymer forms discrete islands or pockets of the second polymer in the first polymer. The second composition may be uniformly blended with the matrix.

In one embodiment, the present invention may comprise a multi-layered structure comprising: (a) a first structural layer; and (b) a second peelable breakaway layer comprising a polymer blend having an inert filler, wherein the filler is substantially dispersed in the polymer blend such that the breakaway layer functions by cohesive failure. In one embodiment, the filler is uniformly dispersed in the blend. In one embodiment, the polymer blend may comprise a first polymer, and a second polymer that is at least partly incompatible in the first polymer, such that the second polymer comprises discrete islands in the first polymer. In one embodiment, about at least 40% of the first polymer and at least about 10% of the second polymer may be used. Or, at least 50% of the first polymer may be used. The islands of the second polymer may be 20 μm or less in diameter. In alternative embodiments, the islands of the second polymer range from about 1 μm to about 20 μm, or from about 5 μm to about 10 μm in diameter.

The multi-layer structure may be applied to a plastic substrate. For example, the breakaway layer may be positioned to be peeled from a substrate comprising a linear polyolefin, and/or a branched-chain polyolefin. Thus, the first polymer may comprise a linear polyolefin and the second polymer may comprise a branched-chain polyolefin. Or, the first polymer may comprise a branched-chain polyolefin and the second polymer may comprise a linear polyolefin. Thus, in one embodiment, the polymer blend may comprise at least 40% of a linear polyolefin and/or at least 10% of a branched-chain polyolefin. Or, the polymer blend may comprise at least 40% of a branched-chain polyolefin and/or at least 10% of a linear polyolefin. Or, the first polymer may comprise a linear or branched chain polyolefin and the second polymer may comprise an acid-modified polyolefin. A variety of linear polyolefins may be used. In one embodiment, at least one of the polymers comprises a polyethylene polymer such as high density PE (HDPE) or isotactic polypropylene. Also a variety of branched-chain polyolefins may be used. In one embodiment, at least one of the polymers may comprise a syndiotactic or atactic polypropylene homopolymer or copolymer, or a polybutylene homopolymer or copolymer. Or, the polymer blend may comprise a branched-chain polymer such as low density PE (LDPE), medium density PE (MDPE), linear low density PE (LLDPE), and/or PE copolymers such as, but not limited to, ethylene vinylacetate (EVA).

A variety of materials may be used as an inert filler. In one embodiment, the inert filler may comprise a particulate inorganic filler. Such inorganic fillers may include talc, calcium carbonate, silica, aluminum trihydrate, feldspar, zeolite, koalinite (aluminum silicate), aluminum oxide, calcined clay, diatomaceous earth, titanium dioxide, barium sulfite, or glass or ceramic microspheres.

Alternatively, the inert filler used in the multi-layer structure may comprise an organic polymer that is at least partly incompatible with the first and second polymers. Where the polymer blend comprises a linear polyolefin and/or a branched-chain polyolefin, such incompatible polymers may comprise a polyamide homopolymer or copolymer (e.g., nylon), polyethylene terephthalate, ethylene vinyl alcohol (EVOH), polyvinylchloride (PVC), polyvinyl alcohol (PVOH), cellulose acetate, polycarbonate, polyethylene naphthalate (PEN), polyglycolic acid (PGA), polystryene, polytetrafluoroethylene (i.e., TEFLON®), or polyoxyethylene.

The inert filler may be used at an amount that promotes cohesive failure, but that does not interfere with other desired properties (e.g., sealant properties, barrier properties, flexibility) of the composition. For example, the inert filler may be used at an amount that comprises about 5% to about 40% by weight of the composition used for the breakaway layer. Or, in alternate embodiments, the inert filler may be used at an amount that comprises about 5% to about 20% by weight, or about 10% to about 20% by weight, or about 10% to about 15% by weight, of the composition used for the breakaway layer. Using a second polymer that is at least partly incompatible with the first polymer may reduce the amount of filler required.

The polymer blend may also include additional polymers. In an embodiment, the multi-layer structure may comprise a composition for adhering the breakaway layer to the structural layer. The composition for adhering the breakaway layer to the structural layer may comprise a polymer that contains at least one acid functionality (e.g., an acid modified polymer). For example, a maleic acid anhydride (MAA) grafted olefin polymer or an MAA copolymer, may be included in the breakaway layer.

Or, the adhesive component may comprise a layer distinct from the breakaway layer. For example, the adhesive component may comprise an ethylene acrylic acid (EAA) grafted polymer or an EAA copolymer, an ethylene-methacrylic acid (EMAA) grafted polymer or an EMAA copolymer, or a maleic acid anhydride (MAA) grafted polymer or a MAA copolymer, as a layer between the breakaway layer and the supportive layer. Alternatively, a dry bond or energy-curable adhesive may be used for adhering the breakaway layer to the supportive layer. For example, dry bond adhesives such as polyurethane or polyester crosslinking polymers that are commercially available may be used. Also, adhesives that may be crosslinked by UV light, an electron beam, or heat may also be employed.

Also, an additional polymer or polymers may be added to the breakaway layer to modify the characteristics of the breakaway layer. For example, for substrates such as containers that include cyclic olefin polymers, a cyclic olefin copolymer (COC) may be included in the polymer blend of the present invention.

The structural layer may provide a supporting layer onto which the breakaway layer is applied. In one embodiment, the structural layer may comprise a metal. Alternatively, the structural layer may comprise a polymer. In yet another embodiment, the structural layer may comprises a cellulosic composition, such as paper, and the like.

Also, other layers in addition to the breakaway layer, structural layer, and adhesive (or bonding) layer may be used in the multi-layered structures of the present invention. Thus, there may be an additional bonding layer(s), or a film layer(s), or a sealant layer(s), in the multi-layered structure. Such layers may be positioned between the breakaway layer and the substrate (e.g., a sealant layer), or between the breakaway layer and the structural layer (e.g., an additional bonding layer or a film layer). Such additional layers may be added using techniques known in the art. Thus, additional layers may be added by extrusion (coextrusion or tandem extrusion), lamination, or other procedures known in the art.

The present invention also comprises articles of manufacture made using the compositions and multi-layer structures of the present invention. Such articles of manufacture include packaging having a peelable multi-layer lidding, as may be used to contain products such as toys, hardware, medical devices, and the like, or as an outer cover to protect food items, or pharmaceuticals.

Thus, in one embodiment, the present invention comprises an article of manufacture comprising a composition that acts as a peelable breakaway layer. In one embodiment, the breakaway layer comprises a first matrix into which is blended a second composition that is at least partly incompatible with the matrix. The matrix may comprise a first polymer, and the second composition may comprise a inert filler. Also, in one embodiment, the second composition may comprise a second polymer. In one embodiment, the second polymer may be at least partly incompatible with the first polymer. In one embodiment, the second composition may be uniformly dispersed in the matrix.

For example, the breakaway layer may comprise a polymer blend comprising an inert filler, wherein the filler is substantially dispersed in the polymer blend. In one embodiment, the filler is uniformly dispersed in the blend. The polymer blend may comprise a variety of polymers to form the blend, depending upon the substrate to which the breakaway layer is to be applied. In one embodiment, the polymer blend may comprise a first polymer, and a second polymer that is at least partly incompatible with the first polymer, such that the second polymer comprises discrete islands in the first polymer. In one embodiment, at least about 40% of the first polymer and about 10% of the second polymer may be used. Or, at least 50% of the first polymer may be used. The first polymer may comprise a linear polyolefin and the second polymer may comprise a branched-chain polyolefin. Or, the first polymer may comprise a branched-chain polyolefin and the second polymer may comprise a linear polyolefin. For example, the polymer blend may comprise at least about 40% of a linear polyolefin and at least 10% of a branched-chain polyolefin. Or, the polymer blend may comprise at least about 40% of a branched-chain polyolefin and at least 10% of a linear polyolefin. Or, the first polymer may comprise a linear or branched chain polyolefin and the second polymer may comprise an acid modified polyolefin. In an embodiment, peeling of the breakaway layer from a substrate to which the peelable composition is applied results in cohesive failure in the breakaway layer.

For example, in one embodiment, at least one of the polymers may comprise a polyethylene homopolymer or copolymer. Alternatively or additionally, at least one of the polymers may comprise a polypropylene homopolymer or copolymer. Alternatively or additionally, at least one of the polymers may comprise a polybutylene homopolymer or copolymer.

The present invention also comprises articles of manufacture made using the multi-layered structures of the present invention. For example, the present invention may comprise an article of manufacture comprising a multi-layered structure, wherein the multi-layered structure comprises a breakaway layer. In one embodiment, the breakaway layer comprises a first matrix into which is blended a second composition that is at least partly incompatible with the matrix. The multi-layer structure may also include a structural layer to which the breakaway layer is adhered or applied. The matrix may comprise a first polymer, and the second composition may comprise an inert filler. Also, in one embodiment, the second composition may comprise a second polymer. The second polymer may be at least partly incompatible with the first polymer. In one embodiment, the second composition may be uniformly dispersed in the matrix.

In one embodiment, the breakaway layer used in the multi-layer structure of the article of manufacture may comprise a polymer blend comprising an inert filler, wherein the filler is substantially dispersed in the polymer blend. In one embodiment, the filler is uniformly dispersed in the blend. The polymer blend may comprise a first polymer, and a second polymer, such that the second polymer comprises discrete islands in the first polymer. In one embodiment, at least about 40% of the first polymer and about 10% of the second polymer may be used. Or, at least 50% of the first polymer may be used. In an embodiment, peeling of the breakaway layer from a substrate to which the breakaway layer is applied occurs by cohesive failure.

The articles of manufacture may be used in peelable multi-layer structures that may be applied to plastic substrates. The first polymer may comprise a linear polyolefin and the second polymer may comprise a branched-chain polyolefin. Or, the first polymer may comprise a branched-chain polyolefin and the second polymer may comprise a linear polyolefin. For example, the polymer blend may comprise at least about 40% of a linear polyolefin and at least 10% of a branched-chain polyolefin. Or, the polymer blend may comprise at least about 40% of a branched-chain polyolefin and at least 10% of a linear polyolefin. Or, the first polymer may comprise a linear or branched chain polyolefin and the second polymer may comprise an acid modified polyolefin. In one embodiment, at least one of the polymers may comprise a linear polyethylene polymer such as HDPE. Or at least one of the polymers may comprise isotactic polypropylene (PP). Also a variety of branched-chain polyolefins may be used. For example, at least one of the polymers may comprise an atactic or syndiotactic PP homopolymer or copolymer, a polybutylene (PB) homopolymer or copolymer, or a branched-chain polyethylene homopolymer, such as LDPE, MDPE, or LLDPE, or copolymer, such as EVA.

A variety of materials may be used as an inert filler. In one embodiment, the inert filler may comprise a particulate inorganic filler. Such inorganic filler may include talc, calcium carbonate, silica, aluminum trihydrate, feldspar, zeolite, koalinite (aluminum silicate), aluminum oxide, calcined clay, diatomaceous earth, titanium dioxide, barium sulfite, or glass or ceramic microsperes. Alternatively or additionally, the inert filler may comprise an organic polymer that is at least partly incompatible with the first and second polymers. Where the polymer blend comprises a linear polyolefin and/or a branched-chain polyolefin, such incompatible polymers may comprise a polyamide homopolymer or copolymer (e.g., nylon), polyethylene terephthalate, ethylene vinyl alcohol (EVOH), polyvinylchloride (PVC), polyvinyl alcohol (PVOH), cellulose acetate, polycarbonate, PEN, polyglycolic acid (PGA), polystryene, polytetrafluoroethylene (i.e., TEFLON®), or polyoxyethylene.

The inert filler may be used at an amount that promotes cohesive failure, but that does not interfere with other desired properties (e.g., sealant properties, barrier properties, flexibility) of the composition. For example, the inert filler may be used at an amount that comprises about 5% to about 40% by weight of the composition used for the breakaway layer. Or, in alternate embodiments, the inert filler may be used at an amount that comprises about 5% to about 20% by weight, or about 10% to about 20% by weight, or about 10% to about 15% by weight, of the composition used for the breakaway layer. Using a second polymer that is at least partly incompatible with the first polymer may reduce the amount of filler that is required.

The polymer used for the breakaway layer may also include additional polymers. In an embodiment, the composition used for the breakaway layer may comprise a component for adhering the breakaway layer to a structural layer. For example, the composition for adhering the breakaway layer to the structural layer may comprise an polymer that contains an acid functionality such as a maleic acid anhydride (MAA) grafted olefin polymer or a MAA copolymer. Or, the adhesive component may comprise a layer distinct from the breakaway layer. For example, the adhesive component may comprise an ethylene acrylic acid (EAA) grafted polymer or copolymer, an ethylene-methacrylic acid (EMAA) grafted polymer or copolymer, or a maleic acid anhydride (MAA) grafted polymer or copolymer. Alternatively, a dry bond or energy-curable adhesive may be used for adhering the breakaway layer to the supportive layer. For example, commercially available dry bond adhesives such as polyurethane or polyester crosslinking polymers may be used. Also, adhesives that may be crosslinked by UV light, an electron beam, or heat may also be employed.

Or, an additional polymer may be added to modify the characteristics of the breakaway layer. For example, for substrates such as containers that include cyclic olefin polymers, a cyclic olefin copolymer (COC) may be included in the polymer blend of the peelable composition or the breakaway layer.

Also, other layers in addition to the breakaway layer, structural layer, and adhesive (or bonding) layer may be used in the multi-layered structures of the articles of manufacture of the present invention. Thus, there may be an additional bonding layer(s), or a film layer(s), or a sealant layer(s), in the article. Such layers (e.g., a sealant layer) may be positioned between the breakaway layer and a substrate to which the breakaway layer is to be applied, or between the breakaway layer and a second layer in the multi-layered structure (e.g., an additional bonding layer or a film layer positioned between the breakaway layer and the structural layer). Such additional layers may be added using techniques known in the art. Thus, additional layers may be added by extrusion (or coextrusion or tandem extrusion), lamination, or other procedures known in the art.

Embodiments of the present invention also comprise methods for making compositions that may be used to make peelable multi-layered structures. In one embodiment, the present invention comprises a method of making a composition for use as a peelable breakaway layer in a multi-layer structure comprising preparing a composition that comprises a matrix into which is added a second component that is at least partly incompatible with the matrix. In one embodiment, the method comprises the steps of: (a) blending a first polymer and a second polymer, such that the second polymer comprises discrete islands in the first polymer; and (b) dispersing an inert filler in the blend. In one embodiment, at least 40% of the first polymer and at least 10% of the second polymer is used for the blend. Or, at least 50% of the first polymer may be used. The islands of the second polymer may be 20 μm or less in diameter. In alternative embodiments, the islands of the second polymer range from about 1 μm to about 20 μm in diameter, or from about 5 μm to about 10 μm in diameter.

The method may further include the step of applying the composition onto a structural layer to make a multi-layer structure. Additionally or alternatively, the composition used as a breakaway layer may be applied to a substrate from which the breakaway layer may be peeled. For example, the breakaway layer may be positioned to be peeled from a substrate comprising a linear polyolefin, and/or a branched-chain polyolefin. Thus, the first polymer may comprise a linear polyolefin and the second polymer may comprise a branched-chain polyolefin. Or, the first polymer may comprise a branched-chain polyolefin and the second polymer may comprise a linear polyolefin. For example, the polymer blend may comprise at least about 40% of a linear polyolefin and/or at least 10% of a branched-chain polyolefin. Or, the polymer blend may comprise at least about 40% of a branched-chain polyolefin and/or at least 10% of a linear polyolefin. Or, the first polymer may comprise a linear or branched chain polyolefin and the second polymer may comprise an acid modified polyolefin. A variety of linear polyolefins may be used. In one embodiment, at least one of the linear polymers comprises a polyethylene polymer such as high density PE (HDPE) or isotactic polypropylene. Also a variety of branched-chain polyolefins may be used. In one embodiment, at least one of the polymers may comprise a syndiotactic or atactic polypropylene homopolymer or copolymer, or a polybutylene homopolymer or copolymer. Or, the polymer blend may comprise a branched-chain polymer such as low density PE (LDPE), medium density PE (MDPE), linear low density PE (LLDPE), and/or PE copolymers such as, but not limited to, ethylene vinylacetate (EVA).

A variety of materials may be used as an inert filler. In one embodiment, the inert filler may comprise a particulate inorganic filler. Such inorganic fillers may include talc, calcium carbonate, silica, aluminum trihydrate, feldspar, zeolite, koalinite (aluminum silicate), aluminum oxide, calcined clay, diatomaceous earth, titanium dioxide, barium sulfite, or glass or ceramic microspheres.

Alternatively, the inert filler used in the multi-layer structure may comprise an organic polymer that is at least partly incompatible with the first and second polymers. Where the polymer blend comprises a linear polyolefin and/or a branched-chain polyolefin, such incompatible polymers may comprise a polyamide homopolymer or copolymer (e.g., nylon), polyethylene terephthalate, ethylene vinyl alcohol (EVOH), polyvinylchloride (PVC), polyvinyl alcohol (PVOH), cellulose acetate, polycarbonate, polyethylene naphthalate (PEN), polyglycolic acid (PGA), polystryene, polytetrafluoroethylene (TEFLON®), or polyoxyethylene.

The inert filler may be used at an amount that promotes cohesive failure, but that does not interfere with other desired properties (e.g., sealant properties, barrier properties, flexibility) of the composition. For example, the inert filler may be used at an amount that comprises about 5% to about 40% by weight of the composition used for the breakaway layer. Or, in alternate embodiments, the inert filler may be used at an amount that comprises about 5% to about 20% by weight, or about 10% to about 20% by weight, or about 10% to about 15% by weight, of the composition used for the breakaway layer. Using a second polymer that is at least partly incompatible with the first polymer may reduce the amount of filler required.

The polymer blend may also include additional polymers. The multi-layer structure made by the methods of the present invention may comprise a composition for adhering a breakaway layer of the present invention to a structural layer to make a laminate. The composition for adhering the breakaway layer to the structural layer may comprise a polymer that contains at least one acid functionality (e.g., an acid-modified polymer). For example, a maleic acid anhydride (MAA) grafted olefin polymer or an MAA copolymer, may be included in the breakaway layer.

Or, the adhesive component may comprise a layer distinct from the breakaway layer. For example, the adhesive component may comprise an ethylene acrylic acid (EAA) grafted polymer or an EAA copolymer, an ethylene-methacrylic acid (EMAA) grafted polymer or an EMAA copolymer, or a maleic acid anhydride (MAA) grafted polymer or a MAA copolymer, as a layer between the breakaway layer and the supportive layer. Alternatively, a dry bond or energy-curable adhesive may be used for adhering the breakaway layer to a supportive layer. For example, dry bond adhesives such as polyurethane or polyester crosslinking polymers that are commercially available may be used. Also, adhesives that may be crosslinked by UV light, an electron beam, or heat may also be employed.

Also, an additional polymer or polymers may be added to the breakaway layer to modify the characteristics of the breakaway layer. For example, for substrates such as containers that include cyclic olefin polymers, a cyclic olefin copolymer (COC) may be included in the polymer blend made by the methods of the present invention.

Also, other layers in addition to the breakaway layer, structural layer, and adhesive (or bonding) layer may be used to make the multi-layered structures of the present invention. Thus, an additional bonding layer(s), or a film layer(s), or a sealant layer(s), may be applied to the breakaway layer or another layer of the multi-layered structures of the present invention. Such layers may be positioned between the breakaway layer and a second layer of the laminate, or between the breakaway layer and the substrate to which the breakaway layer may be attached. Such additional layers may be added using techniques known in the art. Thus, additional layers may be added by extrusion (coextrusion or tandem extrusion), lamination, or other procedures known in the art.

Peelable Multi-Layered Structures

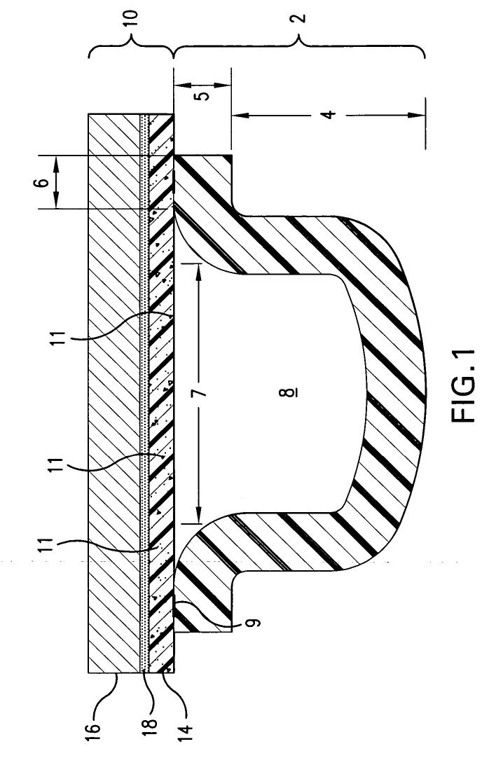

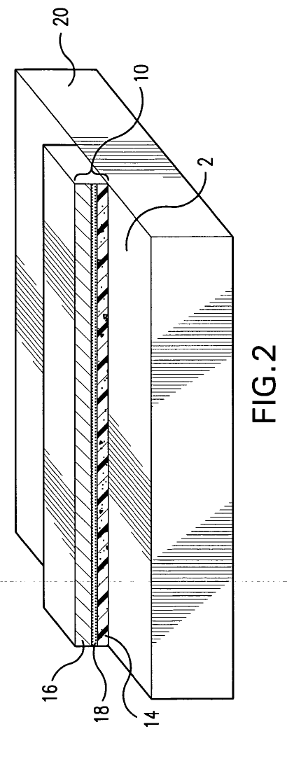

FIGS. 1 and 2 show alternative embodiments whereby a multi-layered structure 10 of the present invention is applied to a substrate 2. As further described herein, the multi-layered structure 10 may comprise a structural layer (or layers) 16 and a peelable breakaway layer 14 comprising a polymer blend that includes an inert filler material 11. The specific polymer blend used for the breakaway layer may vary depending upon the substrate 2 to which the breakaway layer 14 is applied. For example, where the substrate comprises a polyolefin-containing plastic material, the breakaway layer 14 may comprise at least 40% of a linear polyolefin, and at least 10% of a branched-chain polyolefin. Or, the breakaway layer 14 may comprise at least 40% of a branched-chain polyolefin, and at least 10% of a linear polyolefin. Or, the first polymer may comprise a linear or branched chain polyolefin and the second polymer may comprise an acid modified polyolefin. As described herein, the second polymer may comprise discrete islands in the first polymer (not shown in FIG. 1). Also included may be a layer 18, for bonding, or otherwise adhering, the structural layer 16 to the breakaway layer 14 (FIGS. 1 and 2). Also, other layers in addition to the breakaway layer, structural layer, and adhesive (or bonding) layer may be used to make the multi-layered structures of the present invention. Such layers may be positioned between the breakaway layer 14 and the structural layer 16 of the laminate, or between the breakaway layer 14 and the substrate 2 to which the breakaway layer may be applied or attached.

The structural layer 16 of the multi-layer structure 10 may comprise a material that provides strength and overall structural integrity for the multi-layer structure. For example, in one embodiment, the structural layer may comprise a polymer substrate. Or, the structural layer may comprise a cellulosic substrate. Or, a metal-based substrate, such as aluminum foil, may be used. Or, the structural layer may be a multi-layered structure. For example, a laminate of paper and foil, or foil and a polymer film, or a polymer film and paper, or combinations of paper, polymer film, and foil, may be used. As will be apparent to one skilled in the art, the selection, formulation, use, and exact specifications of the structural layer may depend on the application for which the multi-layered structure is to be used.

For example, the structural layer 16 may comprise a cellulosic substrate such as paper, cardboard, or the like. In one embodiment, coated or uncoated bleached paper having a basis weight of from about 15-150 pounds per ream may be used.

Alternatively or additionally, a plastic film layer or laminate may be employed as the structural layer 16. Plastics that may be employed as the structural layer may comprise a polyolefin, polyester, polyamide, polycarbonate, polystyrene, or laminates of these materials. For example, suitable materials for the structural layer may comprise polyethylene (PE), polyethylene terephthalate (PET), polybutylene terephthalate (PBT), copolymers of PET or of PBT (CoPET or CoPBT), polypropylene (PP), propylene ethylene copolymer (PPE), nylon, such as nylon-MXD6 (Mitsubishi Gas Chemical Company, Inc.), polymethylpentene-TPX (Mitsui Chemicals America) or ethylene vinyl alcohol (EVOH) (Kuraray Co. Ltd., Osaka, Japan).

The structural layer 16 may comprise a monolayer or a multi-layer film. Also, oriented polymeric films (e.g., oriented PET films) may be preferred in some embodiments. Oriented films may provide desired mechanical properties, such as temperature stability, lay flat properties, chemical resistance, and printability, as compared to unoriented films. The films may also be stretch-oriented, and in some embodiments monoaxially or biaxially stretch-oriented, in order to improve their mechanical and barrier properties. Alternatively, it may be advantageous in some cases to provide a film with an unbalanced biaxial orientation.

Although oriented PET may be preferred as the structural layer 16, other oriented film materials, such as oriented polypropylene (OPP), oriented ethylene vinyl alcohol (OEVOH), oriented polyamide (OPA), and oriented polyethylene (OPE), or co-extruded films can be used. Alternatively, the structural layer 16 may comprise oriented polyethylene-2,6 naphthalate film containing a polyethylene-2,6 naphthalate resin as a principal component. PET films suitable for use in the present invention are commercially available from a number of sources, such as Mitsubishi Polyester Film (Greer, S.C.), DuPont de Nemours & Company (Wilmington, Del.), and SKC America (Covington, Ga.).

Where improved barrier properties are required, or a foil like appearance is desired, it may also be possible to use a metallized film, such as a metallized oriented film, as at least part of the structural layer 16. In alternative embodiments, the metallized film may comprise metallized polyethylene terephthalate (MPET). Or films coated with organic oxide layers such as Al₂O₃ (e.g., Toppan GL film, Toray Barrialox) or SiOₓ (e.g., Mitsubishi Techbarrier) may be used. Vacuum metallization may be performed commercially (e.g., Camvac Intl., Inc., Morristown, Tenn.; and Vacumet Corporation, Wayne, N.J.). A variety of metals may be used for metallization. In one embodiment, the metal used may be aluminum. The metal or other coating may be applied at a thickness as is required to obtain the desired barrier properties or to highlight the appearance of the structural layer. For example, metallization with aluminum may comprise a thickness that will provide an optical density of about 1.0 to 3.0.

In other embodiments, a metal substrate may be used as the structural layer 16. In one embodiment, the metal may comprise aluminum foil. For example, direct or continuous cast aluminum foil available in a variety of thicknesses is commercially available from suppliers in the art (Alcoa; Alcan; and RJR Packaging). Or, metals such as an iron, steel foil, or a noble metal foil may be used for some applications.

In certain embodiments, the structural layer 16 may comprise a mixture of films, metal-based materials, and/or paperboard. Various polymeric films may be bonded to each other using extrusion or adhesive lamination techniques. For example, paperboard may be bonded to polyolefin with various adhesives such as low density polyethylene or any wet bond adhesive typically used in the art. Similarly, polyesters may be bonded to polyolefins, or biaxially oriented nylon may be bonded to polyolefins such as biaxially oriented polypropylene (BOPP), by means of a polyurethane thermoset adhesive or other adhesives such as adhesives available from commercial suppliers (Henkel Adhesives, Cary, N.C.; Rohm & Haas Company, Chicago, Ill.; Coim USA, Inc., Newport, R.I.).

Depending upon the material used, and the nature of the packaging being made, the structural layer 16 of the multi-layer structure 10 may vary in thickness. In various embodiments, the thickness of the structural layer may range from about 0.0001 inches to about 0.05 inches (2.54 μm to 1,270 μm), or from about 0.0003 inches to about 0.03 inches (7.62 μm to 762 μm), or from about 0.0005 inches to about 0.02 inches (12.7 μm to 508 μm).

The structural layer 16 may include a coloring agent or may be printed in some manner. Or, a counterproof may be deposited for color as is known in the art. For example, a paper layer may be printed using standard printing techniques known in the art. Where the outer layer comprises a polymer film, or a metal-based material, the structural layer may be printed using techniques such as rotogravure or flexographic processes known in the art. In one embodiment, transparent, metallic filled, and/or opaque printing inks may be applied. Or, for metallized films, transparent printing ink that permits the reflectivity of the metallized surface to be apparent may be used.

The multi-layer structure may also comprise a material for adhering or bonding the breakaway layer 14 to the structural layer 16 either directly, or indirectly (e.g., via intervening layers). The selection of the specific material for adhering the breakaway layer 14 to the structural layer 16 may depend upon factors such as the various components of the layers that are to be adhered together, the equipment used to carry out the application of the bonding material to the breakaway layer 14 or to the structural layer 16, the desired bonding strength, and other like factors.

In one embodiment, the composition for adhering the breakaway layer to the structural layer (or to other layers of the multi-layered structure 10) comprises a layer 18 that is separate from the breakaway layer 14 and the structural layer 16. Or the composition for adhering the breakaway layer to the structural layer may comprise a material that is included as part of the breakaway layer 14.

In one embodiment, a wet-bond or dry bond adhesive applied by laminate coating may be used to bond the breakaway layer 14 to the structural layer 16. Typical wet-bond and dry bond adhesive materials may be either thermoplastic or thermoset materials, depending upon the materials to be bonded. For example, where the supportive layer 16 is aluminum foil, and the breakaway layer 14 consists primarily of a polyolefin such as high density polyethylene, the bonding layer 18 may be a commercially available dry bond adhesive such as a thermoset urethane. Or a polypropylene dispersion coating, such as MORPRIME® (Rohm & Hass, Chicago, Ill.) may be used. Or a polyester adhesive or an ethylene acrylic acid based dispersion coating may be used. Also, adhesives that may be crosslinked by UV light, an electron beam, or heat may also be employed. Such adhesives are commercially available from suppliers including Rohm & Hass (Chicago, Ill.) or Henkel Adhesives (Cary, N.C.).

In another embodiment, a thermoplastic bonding agents applied by coextrusion may be used as an adhesive composition. Such bonding agents are typically polyethylene or polypropylene copolymers or grafted polymers known in the art. Example coextrusion bonding agents that may be used in the multi-layer structures of the present invention include the following: polyethylene (PE) homopolymers, such as low density PE (LDPE), medium density PE (MDPE), linear low density PE (LLDPE), and high density PE (HDPE); PE copolymers, such as ethylene-acrylic acid copolymers (EAA) (commercially available as PRIMACOR®, Dow Chemical Company), ethylene methacrylic acid copolymer (EMAA; commercially available as Nucrel® from Dupont Packaging Products, Wilmington, Del.); polypropylene (PP); PP copolymers; and maleic anhydride grafted polymers (commercially available as ADMER® from Mitsui Chemicals America, Inc., Purchase, N.Y.; or BYNEL® from Dupont Packaging Products, Wilmington, Del.). Also, ionomers such as SURLYN® and ethylene vinyl acetate (EVA) polymers (Dupont Packing Products, Wilmington, Del.) may be used as adhesives.

Materials that comprise an adhesive or bonding agent can be applied to the laminate using a variety of techniques, such as wet or dry bond lamination, extrusion lamination, or thermal lamination. In one embodiment, the adhesive or bonding agent may be applied to a substrate in a fluid form, and then the adhesive allowed to set to achieve a desirably high cohesive strength. The transition from fluid to solid may be accomplished by the heating of a thermoplastic, the release of a solvent or carrier, a chemical reaction such as cross-linking, or other suitable mechanism. Typically, wet or dry bond adhesives form layers that are at least about 0.00005 inch (1.27 μm) thick and usually have a thickness of less than about 0.0005 inch (12.7 μm), and often less than about 0.0001 inch (2.54 μm). Extrusion adhesive layers are typically at least 0.0001 inches (2.54 μm) thick and usually have a thickness of less than 0.001 inches (25.4 μm), or in other embodiments, less than 0.0005 inches (12.7 μm).

The selection of the specific material used for the breakaway layer 14 may depend upon the composition of the substrate 2 to which the breakaway layer is sealed or otherwise applied, the equipment used to carry out the sealing process, the desired sealing and opening properties, and other factors related to the packaging being made. Also, the selection of the specific material used for the breakaway layer 14 may depend upon the composition of the structural layer 16 or other layers of the multi-layered structure to which the breakaway layer is applied.

In one embodiment, the breakaway layer may comprise a linear polyolefin and/or a branched polyolefin. This composition may be preferred where the breakaway layer is to be sealed to a polyolefin containing substrate. In contrast, for sealing to a metal, the breakaway layer may comprise a linear polyolefin and/or a branched polyolefin with an acid functionality, such as acrylic acid, methacrylic acid, or maleic acid anhydride.

A variety of polymer materials may be used for the linear polyolefin. For example, the linear polyolefin may comprise a polyethylene (PE) polymer, such as high density PE (HDPE). Or isotactic polypropylene (PP) may be used. The breakaway layer may also comprise branched-chain polyolefins such as atactic and/or syndiotactic polypropylene (PP) hompolymers and/or copolymers, polybutylene (PB) hompolymers and/or copolymers, polyethylene (PE) homopolymers and/or copolymers, such as low density PE (LDPE), medium density PE (MDPE), linear low density PE (LLDPE), and ethylene vinylacetate (EVA), and maleic anhydride grafted branched-chain polyolefins, such as maleic anhydride grafted polypropylene or polyethylene. Also included as part of the breakaway layer 14 may be cyclic olefin copolymers. The inclusion of cyclic olefin copolymers may be preferred where the substrate includes a cyclic olefin polymer. Also, wax and other modifiers may be included to further extend the range of performance properties.

Again referring to FIG. 1, the filler 11 may enhance peelability by shifting seal failure upon peeling from adhesive failure at the interface between the substrate 2 and the multi-layer structure 10, to cohesive failure within the breakaway layer 14 itself. In alternative embodiments, the filler may be included at an amount that is at least about 5 weight percent (wt. %) of the breakaway layer, or from about 5 to 40 wt. %, or from about 5 to 20 wt. %, or from about 10 to 20 wt. %, or 10 to 15 wt. % of the breakaway layer 14. The filler may comprise particles having an average size of about 0.5-10 μm (microns). For example, in one embodiment, talc having an average particle size of about 1-2 μm is used.

The filler may comprise an inert organic or inorganic material. A variety of inorganic fillers may be used. Some suitable inorganic fillers may comprise talc, calcium carbonate, silica, aluminum trihydrate, feldspar, zeolite, koalinite (aluminum silicate), aluminum oxide, calcined clay, diatomaceous earth, titanium dioxide, barium sulfite, or glass or ceramic microspheres. The inert filler may also comprise an organic polymer that is at least partly incompatible with the polymer blend used for the breakaway layer 14. For example, where the breakaway layer 14 includes a linear polyolefin and/or a branched-chain polyolefin, the incompatible polymer may comprise a polyamide homopolymer or copolymer (e.g., nylon), polyethylene terephthalate, ethylene vinyl alcohol (EVOH), polyvinylchloride (PVC), polyvinyl alcohol (PVOH), cellulose acetate, polycarbonate, polyethylene naphthalate (PEN), polyglycolic acid (PGA), polytetrafluoroethylene (TEFLON®), polystryene, or polyoxyethylene.

In some cases, using large amounts of a particulate filler can result in the layer having a opaque appearance. Also, very large amounts of a particulate filler may make processing using conventional extrusion equipment more difficult. By including an incompatible organic polymer in the polymer blend, the amount of inorganic particulate filler may be reduced. Reduction of the particulate filer may be preferred in some embodiments, as for example to provide reduced exposure of the contents of a package to the particulate filler upon peeling of the multi-layer structure, or to aid in manufacture.

The filler is designed to be inert. In some cases, such as where the matrix is a polyolefin, an untreated inorganic filler may be used. For other types of matrix materials, the filler may be provided with a surface coating, such as a carboxylic acid coating to promote incompatibility of the filler with the matrix. As is known in the art, the carboxylic acid in the surface coating may be a mono- or dicarboxylic acid or a mixture of such acids (e.g., U.S. Pat. No. 4,711,673).

Depending upon the material used, and the nature of the packaging being made, the breakaway layer 14 of the multi-layer structure 10 may vary in thickness. In various embodiments, the thickness of the breakaway layer may range from about 0.0001 inches to about 0.005 inches (2.54 μm to 127 μm), or from about 0.0002 inches to about 0.002 inches (5.08 μm to 50.8 μm), or from about 0.0005 inches to about 0.001 inches (12.7 μm to 25.4 μm).

In one embodiment, the multi-layer structure comprising a breakaway layer may be heat-sealed to a substrate. Other types of sealing such as induction sealing and ultrasonic sealing may also be used.

As used herein, a heat seal is a seal that is formed by the application of heat. A heat seal may comprise a sealant selected to melt at the same or a lower temperature than the melting temperatures of other components of the material(s) to be sealed. A heat sealant material may be provided as a part of one layer of a multi-layered structure. Upon melting, the heat sealant can adhere two adjacent surfaces together. As the heat sealant hardens, it provides bonding, and hence a seal, between the two materials being sealed, while substantially maintaining the integrity of the two materials. Thus, as used herein, sealing of two different layers does not result in the complete merging of two layers as one, but may result in melting of at least part of one layer into an adjacent layer.

The substrate 2 may comprise a container (FIG. 1) that has an inner volume 8. Or, the substrate 2 may comprise a surface that is part of a larger structure 20 (FIG. 2). The substrate may comprise the upper surface of a laminate. For example, the substrate may comprise part of a package used for food products, medicine, or other products. Alternatively, the substrate 2 may be part of a structure that is to be covered by the multi-layer structure, such as a structure which may require a protective covering (FIG. 2).

The substrate 2 may comprise a plastic material or a laminate. In one embodiment, the substrate, or the surface of the substrate to be sealed, comprises a linear polyolefin. Or, the substrate may comprise a branched polyolefin. In one example embodiment, the substrate may comprise a linear polyolefin and a branched polyolefin. For example, the substrate may comprise high density polyethylene (HDPE), low density polyethylene (LDPE), polyethylene terephthalate (PET), polypropylene (PP), polybutylene (PB), cyclic olefin copolymers (COC), or other suitable material. Mixtures of materials, such as thermoplastic alloys, also can be employed. In one embodiment, the substrate is manufactured primarily from thermoplastic materials, such as HDPE or PP. Also, the materials used to manufacture the substrate may also include fillers, pigments, stabilizers, processing aids, and other types of ingredients known in the art.

In one example embodiment, the substrate 2 may comprise a main body portion 4 and a sealing region 6 (FIG. 1). The sealing region 6 may be part of a larger part of the substrate such as a flange 5 or the like. The main body portion may possess an inner region 8 within which contents (not shown) of the container may be housed. The main body portion may also possesses an opening 7, through which items can be loaded or otherwise inserted into the container, as well as dispensed therefrom.

The substrate may be designed have a sealing region 6 that is compatible with the material that is being used for the peelable seal (FIG. 1). For example, where the substrate is a container, the sealing region 6 may be designed so that a heat seal 9 may be formed between the breakaway layer 14 and the substrate 2. Thus, a part of the container may be designed to have a portion 5 that includes a sealing region 6 that can be positioned essentially parallel to the outer surface of the breakaway layer 14, in order that a portion of the bottom surface of the multi-layer structure 10 can contact the sealing region 6. In this way, the main body portion 4 of the packaging is not necessarily limited by the type of seal used. Thus, the surface of the portion 5 of the packaging comprising the sealing region 6 may be manufactured from a material to which the multi-layered structure can be applied so as to provide an effective seal, without requiring use of a sealable material in other regions of the substrate, such as the main body portion 4 of a container (FIG. 1).

Substrates may be manufactured from plastic materials in a variety of ways, including injection molding, insert molding, injection blow molding, extrusion blow molding, thermoforming, cold forming, and compression molding techniques. Although, as described above, the surface 6 of the substrate 2 that is adjacent to the breakaway layer 14 can be chemically or physically treated so as to enhance the ability of the multi-layered structure to seal to the substrate, it may be preferred to select materials for the main body portion of the substrate so that such types of treatment are not necessary.

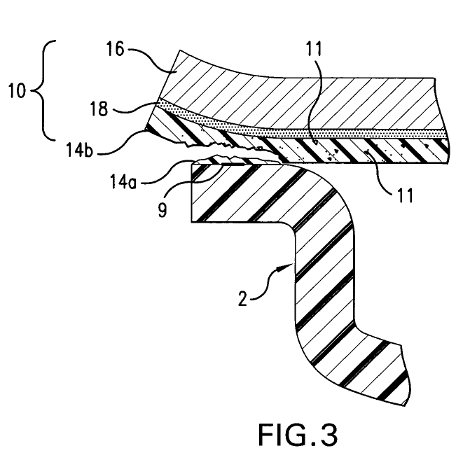

FIG. 3 shows an illustrative embodiment of a multi-layer structure 10 of the present invention being peeled from a substrate 2, where the peeling occurs by cohesive failure within breakaway layer 14. As illustrated in FIG. 3, during cohesive failure, part of the heat-sealable, breakaway layer 14a remains sealed to the substrate, whereas the other part of the layer 14b, remains adhered to the structural layer 16 of the multi-layer structure 10 via bonding layer 18. Generally, the multi-layer structure exhibits cohesive failure where the intra-layer bonding strength of the breakaway layer 14 is less than the strength of bonding of the breakaway layer 14 to both the substrate 2 and to the structural layer 16.

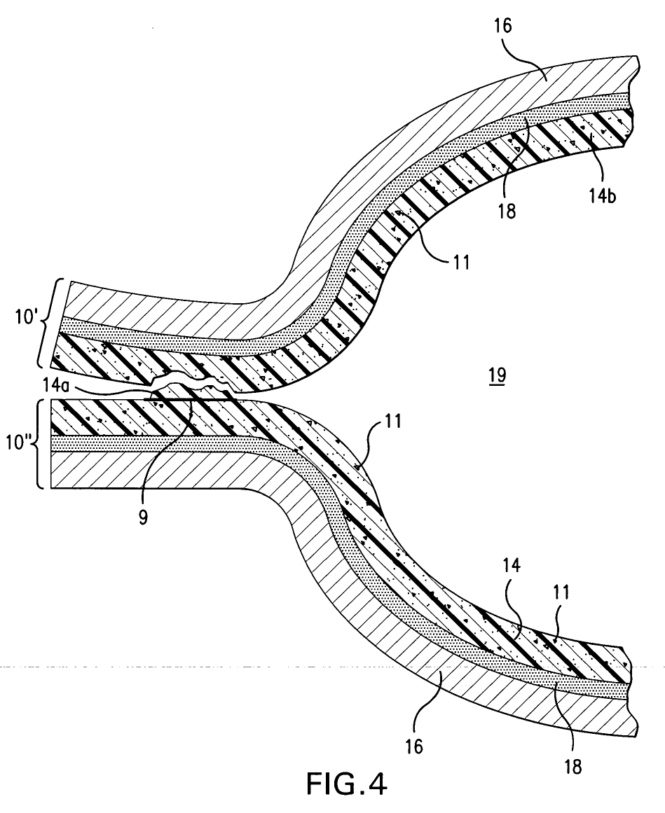

FIG. 4 shows an illustrative embodiment of a multi-layer pouch of the present invention where the breakaway layer may be sealed to itself. Thus, as illustrated in FIG. 4, two multi-layer structures 10′ and 10″ comprising a breakaway layer 14, an adhesive layer 18, and a structural layer 16 may be formed, and the ends of each multi-layer structure 10′ and 10″ sealed to each other as a heat seal 9 to form a sealed inner volume 19 into which an item may be placed. Alternatively, the pouch may be formed from a single multi-layered structure folded to have two of the ends overlaid on top of each other, with the folded multi-layer structure sealed around the perimeter to form an enclosed inner volume. In one embodiment, a heat seal 9 may be used to close the pouch. As illustrated in FIG. 4, the pouch may be opened by pulling the two ends of each multi-layer structure 10′ and 10″ apart at the sealed region 9. In one embodiment, as the two breakaway layers 14 that sealed to form one end of the pouch are pulled apart, there may be cohesive failure in one of the breakaway layers, such that part of the heat-sealable, breakaway layer 14a of one of the multlayered structures 10′ remains sealed to the breakaway layer 14 from the second multi-layered structure 10″, whereas the other part of the layer 14b, remains adhered to the rest of the first multi-layered structure 10′.

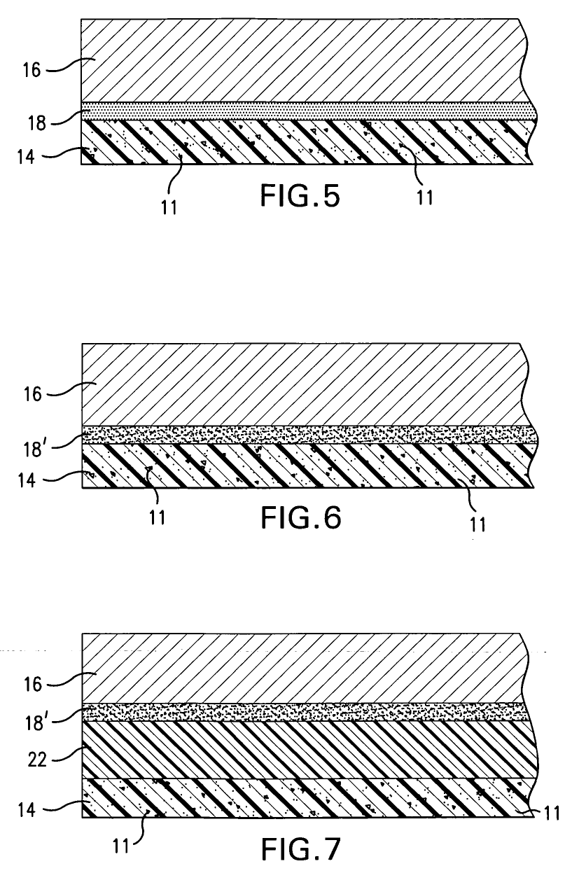

Several embodiments of the multi-structural layers of the present invention are described in Table 1. In addition, illustrative embodiments are shown in FIGS. 5-11. For example, FIG. 5 shows an illustrative embodiment of a peelable multi-layer structure (Laminate A, Table 1) that may be used for a plastic substrate. Laminate A may be used for a substrate comprising a polyolefin such as high density polyethylene (HDPE), polypropylene (PP), or both HDPE or PP. Thus, the peelable multi-layer structure of the present invention as illustrated in FIG. 5 may comprise a structural layer 16 of foil or a laminate, and a breakaway layer 14 comprising at least 40% of a linear polyolefin, such as HDPE, and at least 10% of a branched chain polyolefin, such as atactic PP, and about 10 to 20% of an inert filler 11, such as untreated talc. Or, the breakaway layer may comprise a majority (e.g., at least 40%) of a branched chain polyolefin, such as about 40% polypropylene, and less (e.g., at least 10%) of the linear polyolefin, with the filler. In one embodiment, polybutylene (PB) may be used as the branched-chain polyolefin of the breakaway layer. Also included is a co-extruded bonding layer 18 comprising an adhesion polymer, wherein the bonding layer adheres the substrate layer 16 to the breakaway layer 14. The adhesion polymer may comprise a polymer containing an acid functionality such as an ethylene acrylic acid copolymer, an ethylene methacrylic acid copolymer, or a maleic acid anhydride grafted polyolefin polymer. In one embodiment, the breakaway layer 14 for laminate A (Table 1) ranges from 5 to 20 μm in thickness. Also, the bonding 18 layer may range from about 1 to 10 μm in thickness, and the structural layer 16 may range from about 12 to 250 μm in thickness. Thus, the multi-layer structure may range from about 18 to about 280 μm in thickness.

The type of multi-layer structure shown in FIG. 5 (e.g., Laminate A) may be produced by coextrusion of the breakaway layer and the bonding layer and application of the coextrusion to a structural layer. Or the structural layer may be sequentially coated with the bonding layer followed by the breakaway layer (i.e., tandem extrusion).

TABLE 1
Example Peelable Laminates

| | | | Layer | |
|---|---|---|---|---|
| | Laminate Type and Use | Laminate Formulation | Thickness | |
| A. | Extrusion coated peelable laminate for both | Foil or laminate | 12-250 | μm |
| | high density polyethylene (HDPE) and | Adhesion polymer bonding layer | 1-10 | μm |
| | polypropylene (PP) containers | HDPE + polypropylene (PP) or | 5-20 | μm |
| | | polybutylene (PB) + inert filler | | |
| | | (untreated talc) | | |
| B. | Adhesive laminated peelable laminate for | Foil or laminate | 12-250 | μm |
| | both high density polyethylene (HDPE) and | Dry bond or wet-bond adhesive | 1-5 | μm |
| | polypropylene (PP) containers | Single or multi-layer film composed | 12-50 | μm |
| | | of HDPE + PP (or PB) + inert filler | | |
| | | blend | | |
| C. | Adhesive laminated polyolefin film | Foil or laminate | 12-250 | μm |
| | extrusion coated with peelable blend for | Dry bond or wet-bond adhesive | 1-5 | μm |
| | both high density polyethylene (HDPE) and | Polypropylene film (PP) (oriented or | 10-100 | μm |
| | polypropylene (PP) containers | unoriented) | | |
| | | HDPE + PP (or PB) + Inert filler | 5-20 | μm |
| D. | Extrusion coated peelable laminate for both | Foil or laminate | 12-250 | μm |
| | high density polyethylene (HDPE) and | Adhesion polymer bonding layer | 1-10 | μm |
| | polypropylene containers utilizing sealant | PP + inorganic filler + | 5-20 | μm |
| | layer with incompatible polymer plus | incompatible polymer (PA, PET, | | |
| | inorganic filler | EVOH, etc.) | | |
| E. | Coextrusion coated peelable laminate for | Foil or laminate | 12-250 | μm |
| | both high density polyethylene (HDPE) and | Adhesion polymer bonding layer | 1-10 | μm |
| | polypropylene containers incorporating | HDPE + COC + PB + filler | 5-20 | μm |
| | cyclic olefin copolymer (COC) component | | | |
| F. | Three layer coextrusion coated laminate for | Foil or laminate | 12-250 | μm |
| | peelable seals to either HDPE or PP | Adhesion polymer bonding layer | 1-10 | μm |
| | containers depending on choice of sealant. | HDPE + PB + filler | 5-20 | μm |
| | The sealant layer would stay with the | Sealant layer: HDPE or PP | 1-10 | μm |
| | container and failure would occur within the | | | |
| | breakaway layer | | | |
| G. | Two layers with bonding layer and | Foil or laminate | 12-250 | μm |
| | breakaway as same layer | Maleic anhydride grafted PP + | 5-25 | μm |
| | | inorganic filler | | |
| H. | Peelable blend coextrusion coated with a | Foil or laminate | 12-250 | μm |
| | polyolefin blend | Dry bond adhesive | 1-5 | μm |
| | | PP + PE | 10-100 | μm |
| | | PP + HDPE + Inert filler | 5-20 | μm |
| I. | Adhesive laminated polyolefin film | Foil or laminate | 12-250 | μm |
| | extrusion coated with peelable blend for | Dry bond or wet-bond adhesive | 1-5 | μm |
| | polypropylene (PP) or high density | Polypropylene film (PP) (oriented or | 10-100 | μm |
| | polyethylene (HDPE) containers | unoriented) | | |
| | | PP + HDPE + Inert filler | 5-25 | μm |

FIG. 6 shows an illustrative embodiment of a peelable multi-layer structure (Laminate B, Table 1) that may be used for a plastic substrate. Laminate B may be used for a polyolefin substrate, such as a substrate comprising high density polyethylene (HDPE), or a substrate comprising polypropylene (PP), or a substrate comprising both HDPE and PP. Thus, the peelable multi-layer structure of the present invention as illustrated in FIG. 6 may comprise a structural layer 16 of foil or a laminate, and a breakaway layer 14 comprising at least 40% of a linear polyolefin, such as HDPE, and at least 10% of a branched polyolefin, such as atactic PP, and about 10 to 20% of an inert filler 11, such as untreated talc. Or, the breakaway layer may comprise a majority (e.g., at least 40%) of a branched chain polyolefin, such as about 40% polypropylene, and less (e.g., at least 10%) of the linear polyolefin with the filler. Also, polybutylene may be used as the branched-chain polyolefin of the breakaway layer. Also included is an adhesive layer 18′ comprising an adhesive, such as a polyester or a polyurethane adhesive commercially available from Coim USA, Inc., (Newport, R.I.), Henkel Adhesives (Cary, N.C.), and Rohm & Hass (Chicago, Ill.). Or, a polypropylene dispersion coating, such as MORPRIME® (Rohm & Hass, Chicago, Ill.) may be used. In one embodiment, the breakaway layer 14 ranges from 12 to 50 μm in thickness. Also, in one embodiment, the adhesive layer 18′ ranges from about 1 to 5 μm in thickness, and the structural layer 16 ranges from about 12 to 250 μm in thickness. Thus, the multi-layer structure of FIG. 6 (e.g., Laminate B) may range from about 25 to 305 μm in thickness.

The type of multi-layer structure shown in FIG. 6 may be produced by adhesive lamination of a breakaway layer onto a structural layer. The structural layer may be unwound and a solution adhesive applied to one face. The structural layer with applied adhesive may then be passed through a drying furnace to remove any excess solvent from the adhesive, and the breakaway layer applied using a heated pressure roller as is known in the art. For example, the structure could be produced on a conventional lamination machine such as those manufactured by Valmet Rotomec SPA (Casale-Asti, Italy).

FIG. 7 shows an illustrative embodiment of a multi-layer structure (Laminate C, Table 1) having a polyolefin film 22 extrusion coated with a breakaway layer 14 that may be used for a plastic substrate. Laminate C may be used for a polyolefin substrate, such as a substrate comprising high density polyethylene (HDPE), or a substrate comprising polypropylene (PP), or a substrate comprising both HDPE and PP. Thus, the peelable multi-layer structure of the present invention as illustrated in FIG. 7 may comprise a structural layer 16 of foil or a laminate, a polyolefin film layer 22 such as polypropylene (PP) or polyethylene (PE), and a breakaway layer 14 comprising at least 50% of a linear polyolefin, such as HDPE, and at least 10% of a branched polyolefin, such as atactic PP, and about 10 to 20% of an inert filler 11, such as untreated talc. Or, the breakaway layer may comprise a majority (e.g., at least 40%) of a branched chain polyolefin, such as about 40% polypropylene, and less (e.g., at least 10%) of the linear polyolefin with the filler. In one embodiment, polybutylene may be used as the branched-chain polyolefin in layer 14. Also included is an adhesive layer 18′ comprising an adhesive, such as a polyester or a polyurethane adhesive commercially available from Coim USA, Inc. (Newport, R.I.), Henkel Adhesives (Cary, N.C.), and Rohm & Hass (Chicago, Ill.). Or, a polypropylene dispersion coating, such as MORPRIME® (Rohm & Hass, Chicago, Ill.) may be used. In one embodiment, the breakaway layer 14 ranges from about 5 to 20 μm in thickness, and the polyolefin film layer 22 ranges from about 10 to 100 μm in thickness. Also, in one embodiment, the adhesive layer 18′ ranges from about 1 to 5 μm in thickness, and the structural layer 16 ranges from about 12 to 250 μm in thickness. Thus, the multi-layer structure of FIG. 7 may range from about 28 to 375 μm in thickness.

The type of multi-layer structure shown in FIG. 7 (e.g., Laminate C) may be produced by lamination as is known in the art. For example, the laminate of FIG. 7 may be made by dry bond lamination of the structural layer and the polyolefin film using a laminating machine. Subsequently, the unlaminated surface of the polyolefin film may be extrusion or coextrusion coated with the breakaway composition of layer 14 using an extrusion coating machine commercially available from Crompton Davis-Standard (Somerville, N.J.) or Polytype Converting (Fribourg, Switzerland). Also, as described herein, additional layers may be added. Such additional layers may be added by coextrusion of the breakaway layer 14 and an additional layer to the laminate of the structural layer 16, and the polyolefin film 22, as is known in the art.

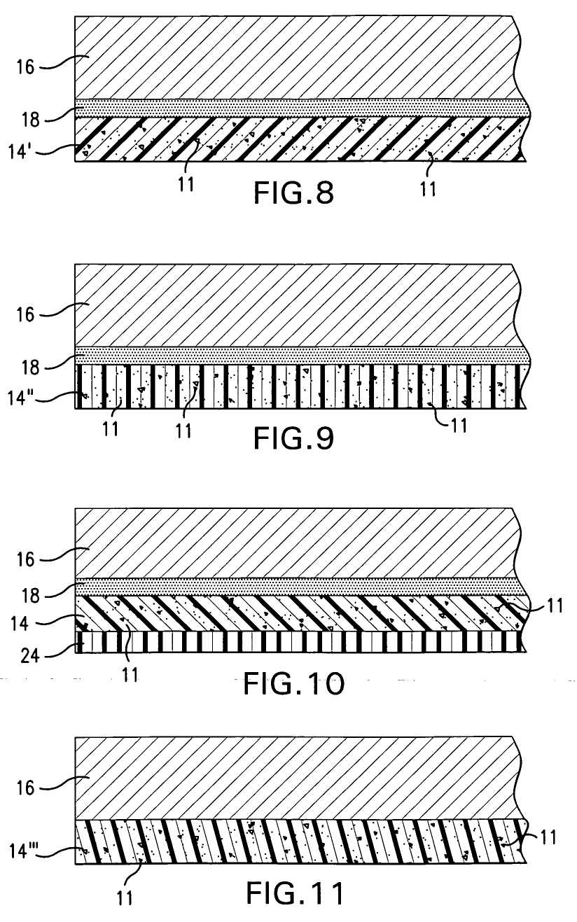

FIG. 8 shows an illustrative embodiment of a coextrusion coated peelable laminate (Laminate D, Table 1) utilizing an incompatible polymer that may be used for a plastic substrate. In one embodiment, the incompatible polymer may increase peelability. Thus, the inert filler may comprise part inorganic filler, and part incompatible polymer acting as an organic filler. Laminate D may be used for a polyolefin substrate, such as a substrate comprising high density polyethylene (HDPE), polypropylene (PP) or both HDPE and PP. Thus, the peelable multi-layer structure of the present invention as illustrated in FIG. 8 may comprise a structural layer 16 of foil or a laminate, and a breakaway layer 14′ comprising at least 40% of a linear polyolefin, such as HDPE, optionally, at least 10% of a branched polyolefin, such as atactic PP, and about 5 to 20% of an inert filler 11, such as untreated talc, and a second polymer that is incompatible with the other polymers in layer 14′. Or, the breakaway layer may comprise a majority (e.g., at least 40%) of a branched chain polyolefin, such as about 40% polypropylene, and less (e.g., at least 10%) of the linear polyolefin with the filler and incompatible polymer. In one embodiment, polybutylene may be used as the branched-chain polyolefin in layer 14′. The incompatible polymer may include a polyamide homopolymer or copolymer (e.g., nylon), polyethylene terephthalate, ethylene vinyl alcohol (EVOH), polyvinylchloride (PVC), polyvinyl alcohol (PVOH), cellulose acetate, polycarbonate, polyethylene naphthalate (PEN), polyglycolic acid (PGA), polytetrafluoroethylene (i.e., TEFLON®), polystryene, or polyoxyethylene.

Also included in Laminate D is a co-extruded bonding layer 18 comprising an adhesion polymer, wherein the bonding layer adheres the substrate layer to the breakaway layer. The adhesion polymer may comprise a polymer containing an acid functionality such as an ethylene acrylic acid copolymer, an ethylene methacrylic acid copolymer, or a maleic acid anhydride grafted polyolefin polymer. In one embodiment, the breakaway layer 14′ of Laminate D may range from 5 to 20 μm in thickness. Also, in one embodiment, the adhesive 18 layer may range from about 1 to 10 μm in thickness, and the structural layer 16 may range from about 12 to 250 μm in thickness. Thus, the multi-layer structure of FIG. 8 may range from 18 to 280 μm in thickness.

The type of multi-layer structure shown in FIG. 8 (Laminate D) may be produced by coextrusion of the breakaway layer and the bonding layer and application of the coextrusion to a structural layer. Or the structural layer 16 may be sequentially coated with the bonding layer followed by the breakaway layer (i.e., tandem extrusion).

FIG. 9 shows an illustrative embodiment of a peelable multi-layer structure (Laminate E, Table 1) that may be used for a plastic substrate. Laminate E may be used for a polyolefin substrate such as a substrate comprising high density polyethylene (HDPE) or polypropylene (PP), or both HDPE and PP. In one embodiment, the substrate may contain a cyclic olefin copolymer (COC). Thus, the peelable multi-layer structure of the present invention as illustrated in FIG. 9 may comprise a structural layer 16 of foil or a laminate, and a breakaway layer 14″ comprising at least 40% of a linear polyolefin, such as HDPE, and at least 10% of a branched polyolefin, such as atactic PP or PB, about 10 to 30% of a cyclic olefin copolymer (COC), and about 10 to 20% of an inert filler 11, such as untreated talc. For example, commercially available COCs such as TOPAS® COC (Celanese) may be used. Also included is a co-extruded bonding layer 18 comprising an adhesion polymer, wherein the bonding layer adheres the substrate layer to the breakaway layer. The adhesion polymer may comprise a polymer containing an acid functionality, such as ethylene acrylic acid copolymer, ethylene methacrylic acid copolymer, or a maleic acid anhydride grafted polyolefin polymer. In one embodiment, the breakaway layer 14″ ranges from 5 to 20 μm in thickness. Also, in one embodiment, the bonding layer 18 ranges from about 1 to about 10 μm in thickness, and the structural layer 16 ranges from about 12 to 250 μm in thickness. Thus, the multi-layer structure of FIG. 9 may range from about 18 to 280 μm in thickness.

As is known in the art, the type of multi-layer structure shown in FIG. 9 (Laminate E) may be produced by coextrusion of the breakaway layer and the bonding layer and application of the coextrusion to a structural layer. Or the structural layer may be sequentially coated with the bonding layer followed by the breakaway later (i.e., tandem extrusion).

FIG. 10 shows an illustrative embodiment of a three-layer peelable multi-layer structure (Laminate F, Table 1). Laminate F utilizes a sealing layer that is a separate layer distinct from the breakaway layer. The material used for the sealing layer may be varied based upon the composition of the substrate to which the sealing layer is being sealed to promote fusion of the sealing layer with the substrate. Where the sealing layer is being adhered to a PP substrate, the sealing layer may comprise PP or ethylene propylene copolymer (EP). For a HDPE substrate, a polyethylene polymer, such as HDPE, MDPE, or LDPE, may be preferred as the sealing layer. Laminate F may be used for a polyolefin substrate such as a substrate comprising high density polyethylene (HDPE) or polypropylene (PP), or both HDPE and PP. Thus, the peelable multi-layer structure of the present invention as illustrated in FIG. 10 may comprise a structural layer 16 of foil or a laminate, and a breakaway layer 14 comprising at least 40% of a linear polyolefin, such as HDPE, and at least 10% of a branched polyolefin, such as PP, and about 10 to 20% of an inert filler 11, such as untreated talc. Or, the breakaway layer may comprise a majority (e.g., at least 40%) of a branched chain polyolefin, such as about 40% polypropylene, and less (e.g., at least 10%) of the linear polyolefin with the filler. Also, polybutylene may be used as the branched-chain polyolefin of the breakaway layer. In addition, the multi-layered structure as shown in FIG. 10 may comprise a sealant layer 24, comprising a polymer that is compatible with the container surface, such as atactic PP or PE, that is distinct from the breakaway layer 14. Also included is a co-extruded bonding layer 18 comprising an adhesion polymer, wherein the bonding layer adheres the substrate layer to the breakaway layer. The adhesion polymer may comprise a polymer containing an acid functionality such as an ethylene acrylic acid copolymer, an ethylene methacrylic acid copolymer, or a maleic acid anhydride grafted polyolefin polymer. In one embodiment, the breakaway layer 14 ranges from 5 to 20 μm in thickness. Also, the sealant layer 24 may range from about 1 to 10 μm in thickness, and the bonding layer 18 may range from about 1 to 10 μm in thickness, and the structural layer 16 may range from about 12 to 250 μm in thickness. Thus, the multi-layer structure of FIG. 10 (Laminate F, Table 1) may range from about 19 to 290 μm in thickness.

In one example embodiment, the type of multi-layer structure shown in FIG. 10 (e.g., Laminate F) may be produced by coextrusion coating of the bonding layer, the breakaway layer, and the sealant layer simultaneously onto a structural layer, or by a combination of coextrusion and tandem extrusion.

FIG. 11 shows an illustrative embodiment of a peelable multi-layer structure (Laminate G, Table 1) that may be used for a plastic substrate that may be formed by direct lamination or extrusion coating of a breakaway layer 14′″ to a structural layer 16. Laminate G may be used for a polyolefin substrate such as a substrate comprising high density polyethylene (HDPE) or polypropylene (PP), or both HDPE and PP. Thus, the peelable multi-layer structure of the present invention as illustrated in FIG. 11 may comprise a structural layer 16 of foil or a laminate, and a breakaway layer 14′″ comprising a linear polyolefin, such as HDPE or a branched polyolefin, such as atactic PP, where at least a portion of the polymer is made to include an acid functionality and about 10 to 20% of an inert inorganic filler 11, such as talc. Also, polybutylene may be used as the branched-chain polyolefin of the breakaway layer. The acid functionality may be introduced by copolymerization or grafting as is known in the art. Example acid functionalities may include, but are not limited to, acrylic acid, methacrylic acid, or maleic acid. The compounds providing an acid functionality may include both polar and nonpolar functional groups that may bond to talc and other inert fillers or incompatible polymers to thereby modify the nature of the incompatible fraction. Thus, the exact acid groups used may depend both on the structural layer to which the breakaway layer is bonded, as well as the composition of the breakaway layer. In one embodiment, the breakaway layer 14′″ of laminate G ranges from about 5 to 25 μm in thickness, and the structural layer 16 may range from about 12 to 250 μm in thickness. Thus, the multi-layer structure of FIG. 11 (Laminate G) may range from about 17 to 275 μm in thickness.

The type of multi-layer structure shown in FIG. 11 (e.g., Laminate G) may be produced by direct extrusion of the breakaway layer 14 onto the structural layer 16 or thermal lamination of a film layer produced from the blend onto the structural layer.

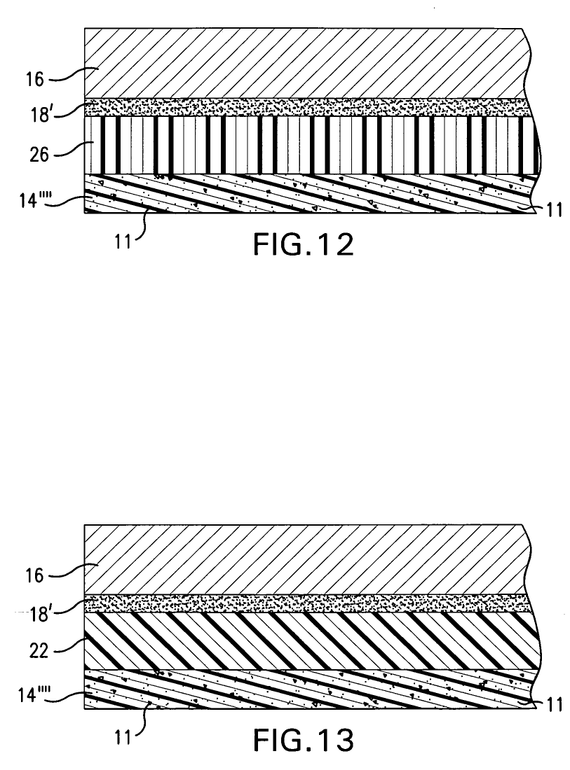

FIG. 12 shows an illustrative embodiment of a multi-layer structure (Laminate H, Table 1) having a polyolefin-containing bonding layer 26 extrusion coated with a breakaway layer 14″″. In the embodiment shown in FIG. 12, the composition used for the breakaway layer comprises a branched-chain polyolefin as the major component. Laminate H may be used for a polyolefin substrate, such as a substrate comprising polypropylene (PP), or for a substrate comprising high density polyethylene (HDPE), or a substrate comprising both HDPE and PP. Thus, the peelable multi-layer structure of the present invention as illustrated in FIG. 12 may comprise a structural layer 16 of foil or a laminate, a coextruded polyolefin bonding layer such as a polypropylene/polyethylene blend 26, and a breakaway layer 14″″ comprising at least 40% of a branched-chain polyolefin, such as PP, and at least 10% of a linear polyolefin, such as HDPE, and about 10 to 20% of an inert filler 11, such as untreated talc. In another embodiment, the breakaway layer may comprise at least 40% of a linear polyolefin, such as PE, and at least 10% of a branched-chain polyolefin, such as PP, and about 10 to 20% of an inert filler 11, such as untreated talc (i.e., layer 14 of laminate A or C). In one embodiment, polybutylene may be used as the branched-chain polyolefin in the breakaway layer.

The bonding layer 26 of laminate H may comprise a polyolefin blend having a branched-chain polyolefin (e.g., polypropylene or polybutylene) as the major (or only) component. Or, the bonding layer may comprise a polyolefin blend having a linear polyolefin (e.g. polyethylene) as the major (or only) component. Also included is an adhesive layer 18′ comprising an adhesive, such as polyester and polyurethane adhesives commercially available from Coim USA, Inc., (Newport, R.I.), Henkel Adhesives (Cary, N.C.), and Rohm & Hass (Chicago, Ill.). Or, a polypropylene dispersion coating, such as MORPRIME® (Rohm & Hass, Chicago, Ill.) may be used. In one embodiment, the breakaway layer 14″″ ranges from about 5 to 20 μm in thickness, and the polyolefin bonding layer 26 ranges from about 5 to 100 μm in thickness. Also, in one embodiment, the adhesive layer 18′ ranges from about 1 to 5 μm in thickness, and the structural layer 16 ranges from about 12 to 250 μm in thickness. Thus, the multi-layer structure of FIG. 12 may range from about 23 to 275 μm in thickness. Alternatively, and as described above (e.g., Laminate B), the coextruded layer bonding layer 26 may be omitted.

In one example embodiment, the type of multi-layer structure shown in FIG. 12 (e.g., Laminate H) may be produced by solution coating of the adhesive layer 18′ onto the structural layer 16, and passing the coated structural layer through a furnace to evaporate any excess solvent and to fuse the adhesive layer to the structural layer. The polyolefin bonding layer 26 and breakaway layer 14 may then be coextrusion coated on to the adhesive surface of the structural layer.

FIG. 13 shows an illustrative embodiment of a multi-layer structure (Laminate I, Table 1) having a polypropylene film 22 extrusion coated with a breakaway layer 14″″ where the composition used for the breakaway layer comprises a branched-chain polyolefin as the major component. Laminate I may be used for a polyolefin substrate, such as a substrate comprising polypropylene (PP), or a substrate comprising high density polyethylene (HDPE), or a substrate comprising both HDPE and PP. Thus, the peelable multi-layer structure of the present invention as illustrated in FIG. 13 may comprise a structural layer 16 of foil or a laminate, a polyolefin film layer 22 such as polypropylene (PP) or polyethylene (PE), and a breakaway layer 14″″ comprising at least 50% of a branched-chain polyolefin, such as PP, and at least 10% of a linear polyolefin, such as HDPE, and about 10 to 20% of an inert filler 11, such as untreated talc. In one embodiment, polybutylene may be used as the branched-chain polyolefin in layer 14. Also, in one embodiment, the polyolefin film layer 22 comprises the polyolefin used as the major component of the breakaway layer. Thus, for laminate I, the polyolefin film layer 22 may comprise predominantly PP. In contrast, and for laminate C above, the polyolefin film layer 22 may comprise predominantly PE. Also included is an adhesive layer 18′ comprising an adhesive, such as polyester and polyurethane adhesives commercially available from Coim USA, Inc. (Newport, R.I.), Henkel Adhesives (Cary, N.C.), and Rohm & Hass (Chicago, Ill.). Or, a polypropylene dispersion coating, such as MORPRIME® (Rohm & Hass, Chicago, Ill.) may be used. In one embodiment, the breakaway layer 14 ranges from about 5 to 20 μm in thickness, and the polyolefin film layer 22 ranges from about 10 to 100 μm in thickness. Also, in one embodiment, the adhesive layer 18′ ranges from about 1 to 5 μm in thickness, and the structural layer 16 ranges from about 12 to 250 μm in thickness. Thus, the multi-layer structure of FIG. 13 may range from about 28 to 375 μm in thickness.

The type of multi-layer structure shown in FIG. 13 (e.g., Laminate I) may be produced by lamination as is known in the art. For example, the laminate of FIG. 13 may be made by dry bond lamination of the structural layer and the polyolefin film using a laminating machine. Subsequently, the unlaminated surface of the polyolefin film may be extrusion coated with the breakaway composition of layer 14″″ using an extrusion coating machine commercially available from Crompton Davis-Standard (Somerville, N.J.) or Polytype Converting (Fribourg, Switzerland).

As is known in the art, intermediate layers may be added to each of the laminates to improve adhesion of the layers to each other. For example, the polyolefin film of laminates C and I, may also be coextrusion coated with the breakaway layer (i.e., 14 or 14″″) in combination with a layer that comprises a single polyolefin (e.g., HDPE or PP), or a polyolefin blend to improve adhesion between the breakaway layer 14 and the polyolefin film layer 22. In one embodiment, the intervening layer may comprise the same, or a similar polymer blend to that used in the breakaway layer but without the added filler. For example, Laminate C may comprise an intervening layer, positioned between 14 and 22, of at least 40% HDPE, and at least 10% PP coextruded with the breakaway layer 14 of at least 40% HDPE, and at least 10% PP and at least 10% talc. Or, the intervening layer may comprise only HDPE or only PP, or variations of a blend of HDPE or PP. Or, other polyolefins may be used. Similarly, Laminate I may comprise an intervening layer, positioned between 14″″ and 22, of at least 40% PP, and at least 10% HDPE coextruded with the breakaway layer 14″″ of at least 40% PP, and at least 10% HDPE and at least 10% talc. Or, the intervening layer may comprise only HDPE or only PP, or variations of a blend of HDPE or PP.

Methods of Making Compositions for Use in Peelable Multi-Layered Structures

Embodiments of the present invention also comprise methods of making peelable multi-layered structures and compositions for making such structures. In one embodiment, the method may comprise the steps of blending a first polymer and a second polymer, such that the second polymer comprises discrete islands in the linear polymer; and dispersing an inert filler in the blend such that the filler is uniformly dispersed in the blend. In one embodiment at least about 40% by weight of the first polymer and at least about 10% by weight of the second polymer are used. Or, at least about 50% of the first polymer may be used. The filler may be substantially dispersed in the polymer blend. In alternate embodiments, a substantially dispersed filler is at least 75% dispersed, or at least 85% dispersed, or at least 95% dispersed, or at least 98% dispersed, or at least 99% dispersed in the polymer blend, wherein 100% dispersion is a completely uniform mixture. As used herein, dispersion of the filler in a polymer comprises mixing of the filler in the polymer such that individual filler particles do not agglomerate with each other.

The first and second polymers of the polymer blend are by definition different from each other. In one embodiment, the first polymer may comprise a linear polymer and the second polymer may comprise a branched-chain polymer. Or, the first polymer may comprise a branched-chain polymer and the second polymer may comprise a linear polymer. In one embodiment, the linear polymer may comprise a linear polyolefin and the branched polymer may comprise a branched polyolefin. The first polymer may provide a matrix into which a second component that is at least partly incompatible with the first polymer is added. In one embodiment, the at least partly incompatible component is an inert filler. Additionally or alternatively, a second polymer that is at least partly incompatible with the first polymer is added. Addition of a second polymer that is incompatible with the first polymer may allow for less filler to be used. In this way, a breakaway layer that is sealed or otherwise bonded to a substrate, will fail by cohesive failure due to the lack of cohesion of the material used to make the breakaway layer.

As described above, a variety of linear polyolefins may be used. In one embodiment, at least one of the polymers comprises a polyethylene polymer such as high density PE (HDPE) or isotactic polypropylene. Also a variety of branched-chain polyolefins may be used. In one embodiment, at least one of the polymers may comprise a syndiotactic or atactic polypropylene homopolymer or copolymer, or a polybutylene homopolymer or copolymer. Or, the polymer blend may comprise a branched-chain polymer such as low density PE (LDPE), medium density PE (MDPE), linear low density PE (LLDPE), and/or PE copolymers such as, but not limited to, ethylene vinylacetate (EVA).

The discrete islands of the second polymer may be within a particular size range. In an embodiment, the discrete islands may be less than 20 m in diameter. In alternative embodiments, the islands of second polymer may range from about 5 μm to about 10 μm in diameter.

To make the compositions of the present invention, the dispersions may be accomplished using a twin screw compounding extruder. For example, a WP53 Extruder, commercially available from Werner & Pfleider, may be used. The inert filler may be any inorganic particulate commonly used as filler. For example, talc, commercially available from Luzenac may be used. For extrusion at higher temperatures, a vacuum may be applied to remove any water that may be bound to the inert filler. This can be important to avoid gassing at the elevated temperature (e.g., about 500° F.) used for extrusion coating. In an embodiment, a master batch comprising excess talc (e.g., 40%) may be produced that is then dry blended with HDPE prior to extrusion. The blend may then be mixed as a dry blend of 25-50% master batch with 50-75% of virgin polymer with an extruder to form the final material to be used as the breakaway material.

### EXAMPLE

### Example 1

Polymer blends having increasing amounts of HDPE mixed with either PB or PP, mixed with various amounts of filler as shown in Table 2 were prepared. Each blend was coextrusion coated onto 0.00175 inch (44.5μ) (micron) aluminum foil using a 6μ bonding layer composition of 9.5% ethylene acrylic acid (EAA) copolymer. Sealant thickness was held constant at 13.5μ. The laminate was then sealed to one of the following substrates: (i) itself; (ii) polypropylene (PP); or (iii) high density polyethylene (HDPE).

Each peelable composition was sealed at various temperatures (350° F.; 400° F., and 450° F.) to itself; PP; or HDPE. Sealing was accomplished by pressing the seal surfaces together for 1 second at 40 PSI using heated flat dies (SENTINEL® Brand Heat Sealer Model 24-ASG; Sencorp Systems, Inc; Hyannis, Mass.) After sealing, the strength of the seal of the blend to the substrate was measured. It was found that sealing at lower temperatures (e.g., 250° F., 300° F.) resulted in no seal. Sealing at higher temperatures resulted in peelable seals exhibiting cohesive failure of the breakaway layer. The seal strength was measured as the pounds of force required to peel the substrates apart and cause cohesive failure of the seal. The type of failure (i.e., cohesive failure vs. adhesive failure) was determined by visual observation of the peeled seal.

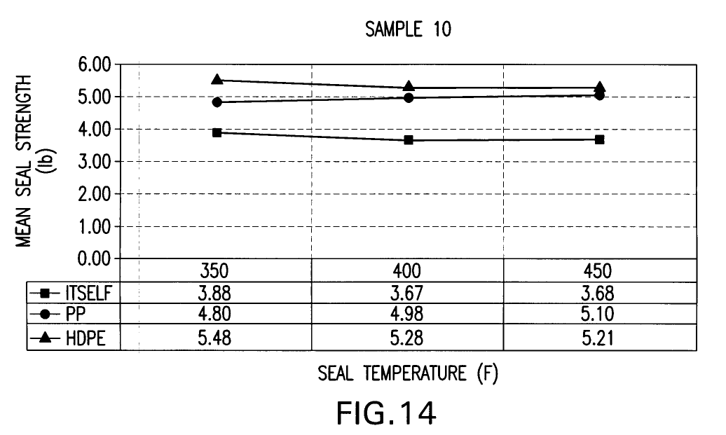

Results are shown in Table 2. A graph illustrating the results for Sample 10 is shown in FIG. 14. It was found that the blends exhibited relatively constant seal strength over the range of temperatures used for sealing. Laminates that displayed consistent cohesive failure across all the seal temperature were Laminates 4, and 6-10(Table 2).

TABLE 2

| | HDPE | PB | Talc | PP | | Sealing | Mean Seal (±0.5 lb) | | |
|---|---|---|---|---|---|---|---|---|---|
| *No. | (%) | (%) | (%) | (%) | Comments | Temperature | Self | PP | HDPE |
| 1 | 90 | 10 | 0 | 0 | Adhesive failure for some | 350 | 3.27 | 2.48 | 5.66 |
| | | | | | samples | 400 | 4.07 | 2.87 | 5.88 |
| | | | | | | 450 | 5.34 | 4.66 | 6.61 |
| 2 | 85 | 15 | 0 | 0 | Adhesive failure for some | 350 | 4.82 | 6.01 | 5.15 |
| | | | | | samples | 400 | 4.63 | 6.41 | 5.05 |
| | | | | | | 450 | 4.84 | 5.75 | 6.12 |
| 3 | 80 | 20 | 0 | 0 | Adhesive failure for some | 350 | 4.49 | 4.70 | 4.32 |
| | | | | | samples | 400 | 4.51 | 4.98 | 4.66 |
| | | | | | | 450 | 4.59 | 6.81 | 5.06 |
| 4 | 70 | 10 | 20 | 0 | Cohesive Failure | 350 | 3.88 | 4.80 | 5.48 |
| | | | | | | 400 | 3.67 | 4.98 | 5.28 |
| | | | | | | 450 | 3.68 | 5.10 | 5.21 |
| 5 | 75 | 15 | 10 | 0 | Cohesive Failure for most | 350 | 2.96 | 5.05 | 5.69 |
| | | | | | samples | 400 | 5.68 | 5.07 | 4.01 |
| | | | | | | 450 | 4.51 | 4.89 | 5.05 |
| 6 | 70 | 20 | 10 | 0 | Cohesive Failure | 350 | 3.76 | 5.69 | 4.82 |
| | | | | | | 400 | 3.79 | 5.67 | 4.93 |
| | | | | | | 450 | 3.78 | 5.52 | 4.88 |
| 7 | 60 | 20 | 20 | 0 | Cohesive Failure | 350 | 2.50 | 5.08 | 3.73 |
| | | | | | | 400 | 2.57 | 4.86 | 3.68 |
| | | | | | | 450 | 2.62 | 4.92 | 3.85 |
| 8 | 65 | 15 | 20 | 0 | Cohesive Failure | 350 | 2.94 | 4.71 | 4.02 |
| | | | | | | 400 | 2.89 | 4.93 | 4.02 |
| | | | | | | 450 | 2.76 | 4.60 | 4.05 |
| 9 | 40 | 0 | 20 | 40 | Cohesive Failure | 350 | 1.51 | 2.49 | 2.18 |
| | | | | | | 400 | 1.74 | 2.50 | 2.26 |
| | | | | | | 450 | 1.66 | 2.54 | 2.28 |
| 10 | 60 | 0 | 10 | 30 | Cohesive Failure | 350 | 2.25 | 3.04 | 2.90 |
| | | | | | | 400 | 2.28 | 3.22 | 3.12 |
| | | | | | | 450 | 2.33 | 3.22 | 3.04 |
| 11 | 45 | 0 | 10 | 45 | Cohesive Failure | 350 | 2.06 | 2.44 | 2.24 |
| | | | | | | 400 | 2.05 | 2.61 | 2.19 |
| | | | | | | 450 | 2.02 | 2.58 | 2.22 |

*Samples 1-3 are controls; samples 4-11 are examples of the present invention.

It should be understood that various changes and modifications to the embodiments described herein will be apparent to those skilled in the art. Such changes and modifications can be made without departing from the spirit and scope of the present invention and without diminishing its attendant scope and/or advantages.

That which is claimed is:

1. A composition for use as a peelable breakaway layer in a multi-layer structure comprising a first matrix into which is blended a second composition that is at least partly incompatible with the matrix.

2. The composition of claim 1, wherein the matrix comprises a first polymer, and the second composition comprises an inert filler.

3. The composition of claim 2, wherein the second composition further comprises a second polymer.

4. A composition for use as a breakaway layer in a multi-layer structure comprising a polymer blend comprising an inert filler, wherein the filler is dispersed in the polymer blend, and wherein the breakaway layer functions by cohesive failure of the layer.

5. The composition of claim 4, wherein the polymer blend comprises a first polymer and a second polymer, such that the second polymer comprises discrete islands in the first polymer.

6. The composition of claim 5, wherein the polymer blend comprises about at least 40% of the first polymer and about at least 10% of the second polymer.

7. The composition of claim 5, wherein the islands of the second polymer have an average size that is in the range of about 1 μm to about 20 μm in diameter.

8. The composition of claim 5, wherein the islands of the second polymer have an average size that is in the range of from about 5 μm to about 10 μm in diameter.

9. The composition of claim 5, wherein the first polymer comprises a linear polyolefin and the second polymer comprises a branched-chain polyolefin.

10. The composition of claim 5, wherein the first polymer comprises a branched-chain polyolefin and the second polymer comprises a linear polyolefin.

11. The composition of claim 4, wherein at least one of the polymers comprises a polyethylene homopolymer or copolymer.

12. The composition of claim 4, wherein at least one of the polymers comprises a polypropylene homopolymer or copolymer.

13. The composition of claim 4, wherein at least one of the polymers comprises a polybutylene homopolymer or copolymer.

14. The composition of claim 4, wherein the inert filler comprises a particulate inorganic filler.

15. The composition of claim 14, wherein the inorganic filler comprises talc, calcium carbonate, silica, aluminum trihydrate, feldspar, zeolite, koalinite (aluminum silicate), aluminum oxide, calcined clay, diatomaceous earth, titanium dioxide, barium sulfite, glass microspheres, or ceramic microspheres.

16. The composition of claim 4, wherein the inert filler comprises an organic polymer that is at least partly incompatible with the first and second polymers.

17. The composition of claim 16, wherein the at least partly incompatible polymer comprises a polyamide homopolymer or copolymer, polyethylene terephthalate, ethylene vinyl alcohol (EVOH), polyvinylchloride (PVC), polyvinyl alcohol (PVOH), cellulose acetate, polycarbonate, polyethylene naphthalate (PEN), polyglycolic acid (PGA), polytetrafluoroethylene, polystryene, or polyoxyethylene.

18. The composition of claim 4, wherein the filler comprises from about 5 to about 40 weight percent.

19. The composition of claim 4, wherein the polymer blend comprises a polymer at least partly modified with an acid moiety.

20. The composition of claim 19, wherein the acid modified polymer comprises a maleic acid anhydride (MAA) grafted polymer.

21. The composition of claim 4, further comprising a cyclic olefin copolymer as a third polymer.

22. A multi-layered structure comprising a composition for use as a breakaway layer, wherein the breakaway layer comprises a polymer blend comprising an inert filler, wherein the filler is dispersed in the polymer blend, and wherein the breakaway layer functions by cohesive failure of the layer.

23. The multi-layered structure of claim 22, wherein the polymer blend comprises a first polymer and a second polymer, such that the second polymer comprises discrete islands in the first polymer.

24. A multi-layered structure comprising:
(a) a structural layer; and
(b) a peelable breakaway layer comprising a polymer blend comprising an inert filler, wherein the filler is dispersed in the polymer blend.

25. The multi-layered structure of claim 24, wherein the breakaway layer is adhered to a substrate, such that upon peeling of the multi-layered structure from the substrate, there is cohesive failure of the breakaway layer.

26. The multi-layered structure of claim 24, wherein the polymer blend comprises a first polymer and a second polymer, such that the second polymer comprises discrete islands in the first polymer.

27. The multi-layered structure of claim 26, wherein the polymer blend comprises about at least 40% of the first polymer, and about at least 10% of the second polymer.

28. The multi-layered structure of claim 26, wherein the islands of the second polymer have an average size that is in the range of about 1 μm to about 20 μm in diameter.

29. The multi-layered structure of claim 26, wherein the islands of the second polymer have an average size that is in the range of from about 5 μm to about 10 μm in diameter.

30. The multi-layered structure of claim 26, wherein the first polymer comprises a linear polyolefin and the second polymer comprises a branched-chain polyolefin.

31. The multi-layered structure of claim 26, wherein the first polymer comprises a branched-chain polyolefin and the second polymer comprises a linear polyolefin.

32. The multi-layer structure of claim 24, wherein at least one of the polymers comprises a polyethylene homopolymer or copolymer.

33. The multi-layer structure of claim 24, wherein at least one of the polymers comprises a polypropylene homopolymer or copolymer.

34. The multi-layer structure of claim 24, wherein at least one of the polymers comprises a polybutylene homopolymer or copolymer.

35. The multi-layer structure of claim 24, wherein the inert filler comprises a particulate inorganic filler.

36. The multi-layer structure of claim 35, wherein the inorganic filler comprises talc, calcium carbonate, silica, aluminum trihydrate, feldspar, zeolite, koalinite (aluminum silicate), aluminum oxide, calcined clay, diatomaceous earth, titanium dioxide, barium sulfite, glass microspheres, or ceramic microspheres.

37. The multi-layer structure of claim 24, wherein the inert filler comprises an organic polymer that is at least partly incompatible with the polymers in the polymer blend.

38. The multi-layer structure of claim 37, wherein the at least partly incompatible polymer comprises a polyamide homopolymer or copolymer, polyethylene terephthalate, ethylene vinyl alcohol, polyvinylchloride (PVC), polyvinyl alcohol (PVOH), cellulose acetate, polycarbonate, polyethylene naphthalate (PEN), polyglycolic acid (PGA), polytetrafluoroethylene, polystryene, or polyoxyethylene.

39. The multi-layer structure of claim 24, wherein the filler comprises from about 5 to about 40 weight percent of the breakaway layer.

40. The multi-layer structure of claim 24, further comprising a cyclic olefin copolymer as a third polymer in the breakaway layer.

41. The multi-layer structure of claim 24, further comprising a composition for adhering the breakaway layer to the structural layer.

42. The multi-layer structure of claim 41, wherein the composition for adhering the breakaway layer to the structural layer comprises a layer distinct from the breakaway layer.

43. The multi-layer structure of claim 41, wherein the composition for adhering the breakaway layer to the structural layer comprises polymer comprising an acid functionality.

44. The multi-layer structure of claim 43, wherein the composition for adhering the breakaway layer to the structural layer comprises ethylene acrylic acid (EAA), ethylene-methacrylic acid (EMAA), or maleic acid anhydride (MAA).

45. The multi-layer structure of claim 42, wherein the composition for adhering the breakaway layer to the supportive layer comprises an adhesive.

46. The multi-layer structure of claim 24, wherein the structural layer comprises a metal.

47. The multi-layer structure of claim 24, wherein the structural layer comprises a polymer.

48. The multi-layer structure of claim 24, wherein the structural layer comprises a cellulosic composition.

49. A multi-layered structure comprising:
(a) a structural layer; and
(b) a peelable breakaway layer that functions by cohesive failure comprising a first matrix into which is blended a second composition that is at least partly incompatible with the matrix.

50. The multi-layered structure of claim 49, further comprising a composition for adhering the structural layer to the breakaway layer.

51. The multi-layered structure of claim 49, wherein the matrix comprises a first polymer, and the second composition comprises an inert filler.

52. The multi-layered structure of claim 49, wherein the second composition further comprises a second polymer.

53. An article of manufacture comprising a composition for use a peelable breakaway layer that functions by cohesive failure, wherein the composition comprises a polymer blend having a first polymer, and a second polymer, such that the second polymer comprises discrete islands in the first polymer, and an inert filler, wherein the filler is dispersed in the blend.

54. An article of manufacture comprising a composition for use a peelable breakaway layer that functions by cohesive failure, wherein the composition comprises a first matrix into which is blended a second composition that is at least partly incompatible with the matrix.

55. An article of manufacture comprising a multi-layered structure, wherein the multi-layered structure comprises:
(a) a structural layer; and
(b) a peelable breakaway layer that functions by cohesive failure comprising a blend having a first polymer, and a second polymer, such that the second polymer comprises discrete islands in the first polymer, and an inert filler, wherein the filler is dispersed in the blend.

56. An article of manufacture comprising a multi-layered structure, wherein the multi-layered structure comprises:
(a) a structural layer; and
(b) a peelable breakaway layer that functions by cohesive failure, wherein the composition comprises a first matrix into which is blended a second composition that is at least partly incompatible with the matrix.

57. A method of making a composition for use as a peelable breakaway layer in a multi-layer structure comprising the steps of:
(a) blending a first polymer and a second polymer, such that the second polymer comprises discrete islands in the first polymer; and
(b) dispersing an inert filler in the blend the filler, such that the filler is dispersed in the polymer blend.

58. The method of claim 57, wherein the first polymer comprises a linear polyolefin and the second polymer comprises a branched-chain polyolefin.

59. The method of claim 57, wherein the first polymer comprises a branched-chain polyolefin and the second polymer comprises a linear polyolefin.

60. The method of claim 57, wherein at least one of the polymers comprises a polyethylene homopolymer or copolymer.

61. The method of claim 57, wherein at least one of the polymers comprises a polypropylene homopolymer or copolymer.

62. The method of claim 57, wherein at least one of the polymers comprises a polybutylene homopolymer or copolymer.

63. The method of claim 57, wherein the islands of the second polymer have an average size that is in the range of about 1 μm to about 20 μm in diameter.

64. The method of claim 57, wherein the islands of the second polymer have an average size that is in the range of about 5 μm to about 10 μm in diameter.

65. The method of claim 57, wherein the filler comprises from about 5 to about 40 weight percent.

66. The method of claim 57, wherein the first polymer comprises at least 40% of the polymer blend, and the second polymer comprises at least 10% of the polymer blend.

67. The method of claim 57, further comprising applying the composition onto a structural layer to make a peelable laminate.
